(19) United States
(12) Patent Application Publication
(10) Pub. No.: US 2025/0029363 A1
(43) Pub. Date: Jan. 23, 2025

(54) IMAGE PROCESSING SYSTEM, IMAGE PROCESSING METHOD, AND NON-TRANSITORY COMPUTER-READABLE MEDIUM

(71) Applicant: NEC Corporation, Minato-ku, Tokyo (JP)

(72) Inventors: Noboru YOSHIDA, Tokyo (JP); Ikuma UCHIDA, Tokyo (JP); Jianquan LIU, Tokyo (JP)

(73) Assignee: NEC Corporation, Minato-ku, Tokyo (JP)

(21) Appl. No.: 18/715,164

(22) PCT Filed: Dec. 17, 2021
(86) PCT No.: PCT/JP2021/046804

§ 371 Date: May 31, 2024

(51) Int. Cl. G06V 10/74; G06V 10/32; G06V 10/75; G06V 40/10

(52) U.S. Cl. CPC G06V 10/761; G06V 10/32; G06V 10/751; G06V 40/103

(57) ABSTRACT

An image processing system (10) includes a posture estimation acquiring unit (11) configured to acquire an estimation result of estimating a posture of a person included in a first image and a person included in a second image, an object recognition acquiring unit (12) configured to acquire a recognition result of recognizing an object, other than the persons, included in the first image and an object included in the second image, and a similarity determining unit (13) configured to perform a similarity determination of the similarity of the first image to the second image based on the estimation results of the postures of the persons in the first image and the second image acquired by the posture estimation acquiring unit (11) and the recognition results of the object in the first image and the second image acquired by the object recognition acquiring unit (12).

### TECHNICAL FIELD

The present invention relates to image processing systems, image processing methods, and non-transitory computer-readable media.

### BACKGROUND ART

In recent years, image processing techniques have been used that, for example, automatically sort or search for similar images from among a plurality of images. As related art, Patent Literature 1, for example, is known. Patent Literature 1 discloses a technique of estimating the posture of a person from an image captured of that person and searching for an image that includes a posture similar to the estimated posture.

Additionally, Non Patent Literature 1 is known concerning a technique related to human activity recognition. Meanwhile, Non Patent Literature 2 is known concerning a technique related to human pose (skeleton) estimation.

### CITATION LIST

### Patent Literature

Patent Literature 1: Japanese Unexamined Patent Application Publication No. 2019-091138

### Non Patent Literature

Non Patent Literature 1: Chen Gao, Yuliang Zou, and Jia-Bin Huang, “iCAN: Instance-Centric Attention Network for Human-Object Interaction Detection,” arXiv:1808.10437v1 [cs.CV], <URL: https://arxiv.org/abs/1808.10437v1>, 30 Aug. 2018.
Non Patent Literature 2: Zhe Cao, Tomas Simon, Shih-En Wei, and Yaser Sheikh, “Realtime Multi-Person 2D Pose Estimation using Part Affinity Fields,” The IEEE Conference on Computer Vision and Pattern Recognition (CVPR), 2017, pp. 7291-7299.

### SUMMARY OF INVENTION

### Technical Problem

With related art like the one disclosed in Patent Literature 1 above, feature values based on features of a person's posture are used to search for a similar image. The related art, however, focuses only on a person's posture, and thus it may not be able to determine the similarities between images with high accuracy.

In the light of such shortcomings, the present disclosure is directed to providing an image processing system, an image processing method, and a non-transitory computer-readable medium that can improve the accuracy of similarity determination of images.

### Solution to Problem

An image processing system according to the present disclosure includes: posture estimation acquiring means for acquiring an estimation result of estimating a posture of a person included in a first image and a person included in a second image; object recognition acquiring means for acquiring a recognition result of recognizing an object, other than the persons, included in the first image and an object included in the second image; and similarity determining means for performing a similarity determination of the similarity of the first image to the second image based on the estimation results of the postures of the persons and the recognition results of the objects.

An image processing method according to the present disclosure includes: acquiring an estimation result of estimating a posture of a person included in a first image and a person included in a second image; acquiring a recognition result of recognizing an object, other than the persons, included in the first image and an object included in the second image; and performing a similarity determination of the similarity of the first image to the second image based on the estimation results of the postures of the persons and the recognition results of the objects.

A non-transitory computer-readable medium storing an image processing program according to the present disclosure is a non-transitory computer-readable medium storing an image processing program that causes a computer to executes the processes of: acquiring an estimation result of estimating a posture of a person included in a first image and a person included in a second image; acquiring a recognition result of recognizing an object, other than the persons, included in the first image and an object included in the second image; and performing a similarity determination of the similarity of the first image to the second image based on the estimation results of the postures of the persons and the recognition results of the objects.

### Advantageous Effects of Invention

The present disclosure can provide an image processing system, an image processing method, and a non-transitory computer-readable medium that can improve the accuracy of similarity determination of images.

### BRIEF DESCRIPTION OF DRAWINGS

FIG. 1 is an illustration for describing shortcomings of related art;

FIG. 2 is a configuration diagram showing an outline of an image processing system according to an example embodiment;

FIG. 3 is a configuration diagram showing an example of a configuration of an image processing apparatus according to a first example embodiment;

FIG. 4 is a configuration diagram showing another example of a configuration of an image processing apparatus according to the first example embodiment;

FIG. 5 is a flowchart showing an example of an operation of an image processing apparatus according to the first example embodiment;

FIG. 6 shows a pose structure used in an example of an operation of an image processing apparatus according to the first example embodiment;

FIG. 7 is a flowchart showing an example of an operation of an image processing apparatus according to the first example embodiment;

FIG. 8 shows an example of a search performed by an image processing apparatus according to the first example embodiment;

FIG. 9 shows another example of a search performed by an image processing apparatus according to the first example embodiment;

FIG. 10A is an illustration for describing a distance relationship feature value according to a second example embodiment;

FIG. 10B is another illustration for describing a distance relationship feature value according to the second example embodiment;

FIG. 11A is an illustration for describing an orientation relationship feature value according to the second example embodiment;

FIG. 11B is another illustration for describing an orientation relationship feature value according to the second example embodiment;

FIG. 12A is an illustration for describing a positional relationship feature value according to the second example embodiment;

FIG. 12B is another illustration for describing a positional relationship feature value according to the second example embodiment;

FIG. 13 is a flowchart showing an example of an operation of an image processing apparatus according to the second example embodiment;

FIG. 14 is a flowchart showing an example of an operation of an image processing apparatus according to the second example embodiment;

FIG. 15 is a configuration diagram showing an example of a configuration of an image processing apparatus according to a third example embodiment;

FIG. 16 shows an example of detection performed by an image processing apparatus according to the third example embodiment;

FIG. 17 is a flowchart showing an example of an operation of an image processing apparatus according to the third example embodiment;

FIG. 18 is a flowchart showing an example of an operation of an image processing apparatus according to the third example embodiment; and

FIG. 19 is a configuration diagram showing an outline of hardware of a computer according to an example embodiment.

### EXAMPLE EMBODIMENT

Hereinafter, some example embodiments will be described with reference to the drawings. In the drawings, identical elements are given identical reference characters, and their repetitive description will be omitted as necessary.

### (Examinations Leading to Example Embodiments)

As described above, with the related art, a person's posture is estimated from an image, and an image that includes a posture similar to the estimated posture is searched for. However, when a search is performed based only on a person's posture, that search may not necessarily find an image (scene) that the user is hoping for.

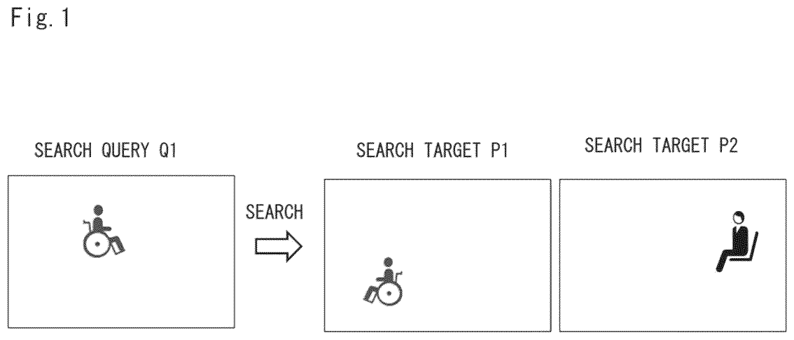

For example, when one is to search for a scene showing a moving self-propelling wheelchair, as shown in FIG. 1, an image showing a person sitting in a wheelchair is set as a search query Q1, and a similar image similar to the search query Q1 is searched for. In this case, the related art locates, from among the search target images, an image like a search target P1 or a search target P2 as a similar image. Since the related art performs a search based only on a person's 20 posture, it locates not only an image showing a person sitting in a wheelchair, as in the search target P1, but also an image showing a person simply sitting in a chair, as in the search target P2. In other words, when a similarity determination is performed based on a feature value of a posture alone, an image showing a person sitting in a chair is also determined as a similar image. Accordingly, the related art may not be able to find an image, with high accuracy, that is close to an image (scene) that the user wants to find.

In another conceivable method, a similar image may be searched for with the use of Human-Object-Interaction (HOI) detection described in Non Patent Literature 1. HOI detection can detect, from an image, a pair containing a person and an object bearing an association with each other and can detect a verb (action) for the person. Performing a similarity determination of images based on a verb for a person detected from a search query and a verb for a person detected from a search target makes it possible to find a similar image with a person and an object taken into consideration.

However, HOI detection presupposes advance preparation through machine learning. Therefore, training is necessary with the use of a large number of images showing interactions between a person and an object. In that case, searching for an image showing a verb that has not been learned beforehand is difficult. Therefore, even with this case, it is not possible to find an image that the user wants with high accuracy.

### Outline of Example Embodiments

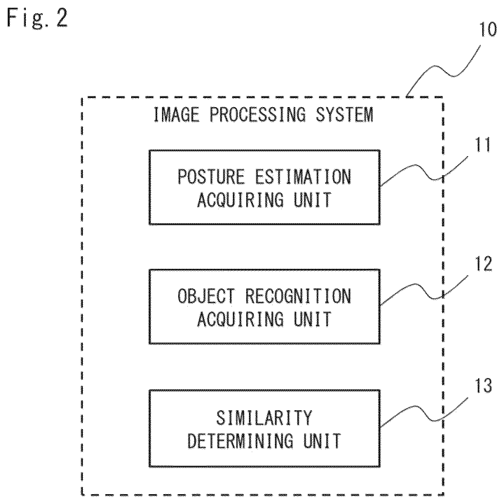

FIG. 2 shows an outline of an image processing system 10 according to an example embodiment. As shown in FIG. 2, the image processing system 10 includes a posture estimation acquiring unit 11, an object recognition acquiring unit 12, and a similarity determining unit 13. Herein, the image processing system 10 may be constituted by a single apparatus or by a plurality of apparatuses.

The posture estimation acquiring unit 11 acquires an estimation result of estimating the posture of a person included in a first image and a person included in a second image. The posture estimation acquiring unit 11 may acquire an estimation result from, for example, a database or may estimate the posture of a person included in a first or a second image by performing a posture estimating process based on the first or the second image. For example, the posture estimation acquiring unit 11 estimates, as the posture of a person included in a first or a second image, the pose (skeleton) structure of the person based on the first or the second image. The object recognition acquiring unit 12 acquires an estimation result of recognizing an object, other than persons, included in a first image and an object included in a second image. The object recognition acquiring unit 12 may acquire a recognition result from, for example, a database or may recognize an object included in a first or a second image by performing an object recognizing process based on the first or the second image. For example, the object recognition acquiring unit 12 recognizes an object class of an object included in a first or a second image based on the first or the second image.

The similarity determining unit 13 performs a similarity determination of the similarity of a first image to a second image based on the estimation results of the postures of the persons in the first and the second image and the recognition results of the objects in the first and the second image. The similarity determining unit 13 may use estimation results and recognition results acquired, for example, from a database or may use an estimation result estimated through a posture estimating process performed based on a first or a second image and a recognition result recognized through an object recognizing process performed based on the first or the second image. For example, the similarity determining unit 13 performs a similarity determination based on an estimation result of a person's posture estimated based on a first image and a recognition result of an object recognized based on the first image as well as an acquired estimation result of a person's posture in a second image and an acquired recognition result of an object in the second image. For example, the similarity determining unit 13 performs a similarity determination of a first image and a second image based on the degree of similarity between the posture feature values that are based on the estimation results of the persons' postures and the degree of similarity between the object feature values that are based on the recognition results of the objects. A similarity determination is a determination of whether two images are similar. For example, two images are determined to be similar when their degree of similarity is higher than a predetermined value, and two images are determined not to be similar when their degree of similarity is lower than the predetermined value.

With a first image being a query image and with a second image being a plurality of search target images, the similarity determining unit 13 may locate an image similar to the query image from among the plurality of search target images based on the result of a similarity determination.

In this manner, according to an example embodiment, a similarity determination of images is performed with the use of a recognition result of an object in addition to an estimation result of a person's posture. This configuration allows for a high-accuracy similarity determination, as compared to the case in which only the posture is used as in the related art. For example, with regard to the example shown in FIG. 1, an example embodiment can determine that the search query Q1 and the search target P1 are similar because the postures and the objects in the two images both have a high degree of similarity, and can determine that the search query Q1 and the search target P2 are not similar because, although the postures in the two images have a high degree of similarity, the objects in the two image have a low degree of similarity.

### First Example Embodiment

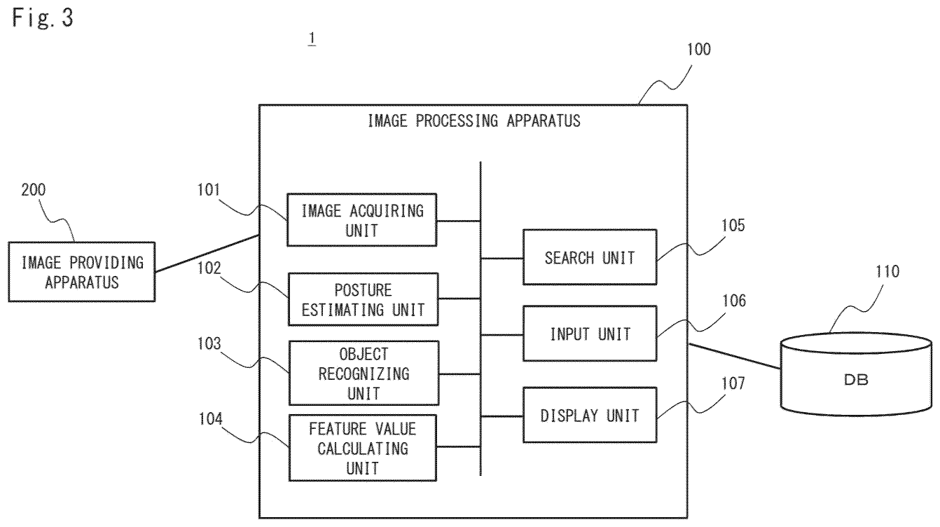

Now, a first example embodiment will be described with reference to some drawings. FIG. 3 shows a configuration of an image processing apparatus 100 according to the present example embodiment.

The image processing apparatus 100, together with a database (DB) 110, constitutes an image processing system 1. The image processing system 1, which includes the image processing apparatus 100, is a system that searches for an image (scene) similar to a search query based on a person's posture estimated from an image and an object recognized from the image.

The image processing system 1 may further include an image providing apparatus 200 that provides an image (search target) to the image processing apparatus 100. For example, the image providing apparatus 200 may be a camera that captures an image or may be an image storing apparatus having an image pre-stored therein. The image providing apparatus 200 generates (stores) a two-dimensional image that includes a person, an object, and so forth, and outputs the generated image to the image processing apparatus 100. The image providing apparatus 200 is connected to the image processing apparatus 100 directly or via, for example, a network so that the image providing apparatus 200 can output an image (video) to the image processing apparatus 100. Herein, the image providing apparatus 200 may be provided within the image processing apparatus 100.

The database 110 is a database that stores, for example, information necessary for the processes of the image processing apparatus 100 or data representing processing results. The database 110 stores, for example, an image (search target) acquired by an image acquiring unit 101, an estimation result of a posture estimating unit 102, a recognition result of an object recognizing unit 103, data for machine learning, a feature value calculated by a feature value calculating unit 104, and a search result of a search unit 105. The database 110 is connected to the image processing apparatus 100 directly or via, for example, a network so that the database 110 can output or receive data to or from the image processing apparatus 100. Herein, the database 110 may be constituted by, for example, a non-volatile memory, such as a flash memory, or a hard disk device and be provided within the image processing apparatus 100.

As shown in FIG. 3, the image processing apparatus 100 includes an image acquiring unit 101, a posture estimating unit 102, an object recognizing unit 103, a feature value calculating unit 104, a search unit 105, an input unit 106, and a display unit 107. The configuration of these units (blocks) is one example, and the image processing apparatus 100 may be constituted by any other units as long as the operations (methods) described later can be implemented. The image processing apparatus 100 is realized, for example, by a computer device, such as a personal computer or a server, that executes a program, and the image processing apparatus 100 may be realized by a single apparatus or by a plurality of apparatuses on a network. For example, the posture estimating unit 102 or the object recognizing unit 103 may be provided as an external device.

The image acquiring unit 101 acquires an image from the image providing apparatus 200. The image acquiring unit 101 acquires a two-dimensional image (a video including a plurality of images) that includes a person, an object, and so forth generated (stored) by the image providing apparatus 200. For example, an image that the image acquiring unit 101 acquires is an image that serves as a search target, and the image acquiring unit 101 stores an acquired image into the database 110.

The posture estimating unit 102 estimates the posture of a person in an image based on the image. Herein, the posture estimating unit 102 may acquire, from an external apparatus (the image providing apparatus 200, the database 110, the input unit 106, or the like), an estimation result of having estimated, in advance, the posture of a person in an image. The posture estimating unit 102 estimates the posture of a person in an acquired search target image and, at the time of a search, estimates the posture of a person in a search query image. The posture estimating unit 102 can be said to include a first posture estimating unit that estimates the posture of a person in a search target and a second posture estimating unit that estimates the posture of a person in a search query.

In this example, the posture estimating unit 102 detects, as the posture of a person, the pose (skeleton) structure of the person from an image. The posture estimating unit 102 may, not limited to detecting the pose structure, estimate the posture (posture label) of a person in an image through a posture estimation engine that uses machine learning. The posture estimating unit 102 detects a two-dimensional pose structure of a person in an image based on the two-dimensional image. The posture estimating unit 102 detects the pose structure of each of the persons recognized in an acquired image. The posture estimating unit 102 detects the pose structure of a person recognized, based on a feature, such as a joint, of the person, with the use of a pose estimation technique that uses machine learning. The posture estimating unit 102 uses, for example, a pose estimation technique such as OpenPose disclosed in Non Patent Literature 2. The posture estimating unit 102 outputs, in addition to the estimated posture (pose structure) of a person, the reliability indicating the reliability of the estimation. As the reliability is higher, the likelihood that the estimated posture of the person is correct (correct person) is higher. The posture estimating unit 102 stores the posture estimation result (the pose structure and the reliability) of the person to be detected into the database 110.

In a pose estimation technique such as OpenPose, a model is trained on image data annotated with various patterns and thus estimates a person's pose (skeleton). A pose (skeleton) structure estimated through a pose estimation technique such as OpenPose includes a “key point,” which is a characteristic point, such as a joint, and a “bone (bone link)” indicating a link between key points. Therefore, the terms “key point” and “bone” may be used below to describe a pose structure, and unless specific limitations indicate otherwise, a “key point” corresponds to a “joint” of a person, and a “bone” corresponds to a “bone” of a person.

The object recognizing unit 103 recognizes an object in an image based on the image. Herein, the object recognizing unit 103 may acquire, from an external apparatus (the image providing apparatus 200, the database 110, the input unit 106, or the like), a recognition result of having recognized, in advance, an object in an image. An object that the object recognizing unit 103 recognizes is an object other than a person, that is, an object other than a person including a person whose posture is estimated (e.g., an object whose class is other than a person). The object recognizing unit 103 recognizes an object in an acquired search target image and, at the time of a search, recognizes an object in a search query image. The object recognizing unit 103 can be said to include a first object recognizing unit that recognizes an object in a search target and a second object recognizing unit that recognizes an object in a search query.

The object recognizing unit 103 recognizes the class of an object in an image. The class of an object indicates the type or the category of the object. The classes of objects may be stratified (subdivided) in accordance with, for example, search conditions. The object recognizing unit 103 recognizes the class of each of the objects in an acquired image. For example, the object recognizing unit 103 may recognize the class of an object in an image through an object recognition engine that uses machine learning. The object recognizing unit 103 can recognize an object upon being trained, through machine learning, on features (patterns) of object images and the classes of objects. The object recognizing unit 103 detects an object region within an image and recognizes the class of an object in the detected object region. The object recognizing unit 103 outputs, in addition to the recognized class of an object, the reliability indicating the reliability of the recognition. As the reliability is higher, the likelihood that the recognized class of the object is correct is higher. The object recognizing unit 103 stores the object recognition result of a search target (the object class and the reliability) into the database 110.

Herein, the object recognizing unit 103 may recognize, not limited to the class of an object, other information regarding features of the object. In one example, the object recognizing unit 103 may recognize the state of an object from the features of each part of the object image. The state of an object is, for example but is not limited to, that a notebook personal computer (PC) is in an open state/closed state, that a PC screen is in a displaying state/non-displaying state, that a vehicle's headlight or blinker is in an on state/off state, or that a vehicle's door is in an open state/closed state. The state of an object in a target image may be stored and serve to enable a search for an image similar in terms of the state of the object in a search query.

The feature value calculating unit 104 calculates a posture feature value that is based on an estimation result of a person's posture estimated (acquired) from an image and also calculates an object feature value that is based on a recognition result of an object recognized (acquired) from an image. The feature value calculating unit 104 calculates a posture feature value of a person and an object feature value of an object in a search target image and calculates a posture feature value of a person and an object feature value of an object in a search query image. The feature value calculating unit 104 can be said to include a first feature value calculating unit that calculates a posture feature value and an object feature value of a search target and a second feature value calculating unit that calculates a posture feature value and an object feature value of a search query. The feature value calculating unit 104 stores, into the database 110, the calculated posture feature value and object feature value of a search target (normalized values if normalized). Herein, the feature value calculating unit 104 may calculate both a posture feature value and an object feature value or may calculate only a posture feature value. For example, the calculation of an object feature value may be omitted if the degree of similarity between objects is to be determined with the use of only the information from the recognition results of the objects (object classes). In this case, information from a recognition result of an object can be said to indicate its object feature value.

The feature value calculating unit 104 calculates the feature value of a two-dimensional pose structure detected as a person's posture. The feature value of a pose structure (posture feature value) indicates a feature of a person's pose (posture) and serves as an element in searching for an image based on the person's pose. The feature value of a pose structure may be the feature value of the entire pose structure, may be the feature value of a part of the pose structure, or may include a plurality of feature values indicating respective parts of the pose structure. In one example, a feature value is, for example, a feature value obtained through machine learning of pose structures or the size, in the image, of the pose structure from the head to the feet. The size of a pose structure is, for example, the area or the height in the top-bottom direction of a pose region that includes the pose structure in the image. The top-bottom direction (height direction or longitudinal direction) is the direction (Y-axis direction) extending between the top and the bottom of an image and is, for example, the direction perpendicular to the ground (reference plane). Meanwhile, the right-left direction (lateral direction) is the direction (X-axis direction) extending between the right and the left of an image and is, for example, the direction parallel to the ground.

The feature value calculating unit 104 may normalize a calculated posture feature value. For example, the feature value calculating unit 104 may use, for example, the minimum value or the maximum value of a pose region or the height of a person as a normalization parameter. For example, the feature value calculating unit 104 calculates the height (the number of the height pixels) of a person in erect posture in a two-dimensional image and normalizes the pose structure (pose information) of the person based on the calculated number of height pixels of the person. The number of the height pixels corresponds to the height of the person in a two-dimensional image (the length of the entire body of the person in the two-dimensional image space). The feature value calculating unit 104 obtains the number of the height pixels (the number of pixels) from the length (the length in the two-dimensional image space) of each bone in the detected pose structure. The feature value calculating unit 104 normalizes the height, in the image, of each key point (feature point) included in the pose structure by the number of the height pixels. The height of a key point can be obtained from the value (the number of pixels) of the Y-coordinate of the key point.

Alternatively, the height direction may be the direction of the vertical projection axis (vertical projection direction) obtained by projecting a vertical axis perpendicular to the ground (reference plane) in the real-world three-dimensional coordinate space onto a two-dimensional coordinate space. In this case, the height of a key point can be obtained by obtaining a vertical projection axis obtained through projecting an axis perpendicular to the ground in the real world onto a two-dimensional coordinate space that is based on a camera parameter and by obtaining the value (the number of pixels) along the vertical projection axis. Herein, a camera parameter is an image capturing parameter, and camera parameters include, for example, the orientation, the position, the shooting angle, or the focal length of a camera. An image of an object whose length or position is known beforehand may be captured with a camera, and the camera parameters can be obtained from that image.

When calculating an object feature value, the feature value calculating unit 104 calculates the feature value of an object recognized from an image. An object feature value indicates a feature of an object in an image and serves as an element in searching for an image based on the object. For example, an object feature value is a feature value of an image of a recognized object. An object feature value may be the feature value of an entire object, may be the feature value of a part of an object, or may include a plurality of feature values of respective parts of an object. In one example, a feature value is, for example, a feature value obtained through machine learning of objects or the size or the shape of a recognized object in the image. The size of an object is, for example, the height in the top-bottom direction, the width in the right-left direction, or the area of the object region that includes the object in the image.

The feature value calculating unit 104 may normalize a calculated object feature value. For example, the feature value calculating unit 104 may use, for example, the minimum value or the maximum value of the object region corresponding to an object class or the height or the width of an object as a normalization parameter. For example, the feature value calculating unit 104 calculates the area of the object region of an object in an image and normalizes the area of the object region of this object based on the minimum value or the maximum value of the area corresponding to the object class.

The search unit (similarity determining unit) 105 search for an image having a high degree of similarity with a search query from among a plurality of search target images stored in the database 110. In this example, a search query (search condition) is a person's posture and an object. The search unit 105 searches for an image corresponding to a search query based on the feature value of a person's posture and the feature value of an object (including the object class) in an image.

The search unit 105 performs a similarity determination of images based on the degree of similarity between the posture feature value of a search query and the posture feature value of a search target and the degree of similarity between the object feature value of the search query and the object feature value of the search target, and locates an image similar to the search query. The search unit 105 searches for an image having a posture feature value with a high degree of similarity with the posture feature value of a search query and an object feature value with a high degree of similarity with the object feature value of the search query. The degree of similarity between feature values is the distance between the feature values. For example, the search unit 105 may perform a similarity determination based on the weight of the degree of similarity between the posture feature values and the weight of the degree of similarity between the object feature values. Furthermore, the search unit 105 may perform a similarity determination based on the reliability of the person whose posture has been estimated and the reliability of the estimated object.

When obtaining the degree of similarity between postures, the search unit 105 may obtain the degree of similarity between the feature values of the entire pose structures or may obtain the degree of similarity between the feature values of parts of the pose structures. For example, the search unit 105 may obtain the degree of similarity between the feature values of first parts (e.g., the hands) and between the feature values of second parts (e.g., the feet) of the pose structures. Meanwhile, when obtaining the degree of similarity between objects, the search unit 105 may obtain the degree of similarity between the feature values of the entire objects or may obtain the degree of similarity between the feature values of parts of the objects. The search unit 105 may use the result of determining whether the object classes match as the degree of similarity, or when object classes are stratified, the search unit 105 may use the result of determining whether the object classes match completely or partly as the degree of similarity.

The search unit 105 may perform a search based on the posture feature value and the object feature value of each image or may perform a search based on a change in the posture feature value and the object feature value (including the object class) across a plurality of chronologically consecutive images (video). Specifically, the search unit 105 may store a video, not limited to images, and may search for a video showing a person's posture and an object similar to those in a search query video. The search unit 105 detects the degree of similarity between the feature values on a frame by frame (image by image) basis. For example, the search unit 105 may extract a key frame from a plurality of frames and determine the degree of similarity using the extracted key frame. By searching for a video similar to a search query video, the search unit 105 can perform a search with a change in a person's posture or in the relationship between a person and an object used as a search key. For example, the search unit 105 can perform a search with a change in an object used as a search key, as in the case in which a person puts down a glass and picks up a smartphone.

The input unit 106 is an input interface that acquires information input by a user operating the image processing apparatus 100. The input unit 106 is, for example, a graphical user interface (GUI) and receives input of information corresponding to the user operation from an input device, such as a keyboard, a mouse, or a touch panel. For example, the input unit 106 receives, as a search query, a person's posture and an object specified from a plurality of images. The user may manually input a person's posture (pose) and the class of an object to be used as a search query.

The display unit 107 is a display unit that displays, for example, the result of an operation (process) performed by the image processing apparatus 100. The display unit 107 is, for example, a display device, such as a liquid-crystal display or an organic electroluminescence (EL) display. The display unit 107 displays, on the GUI, the result of processing performed by each unit, such as a search result of the search unit 105.

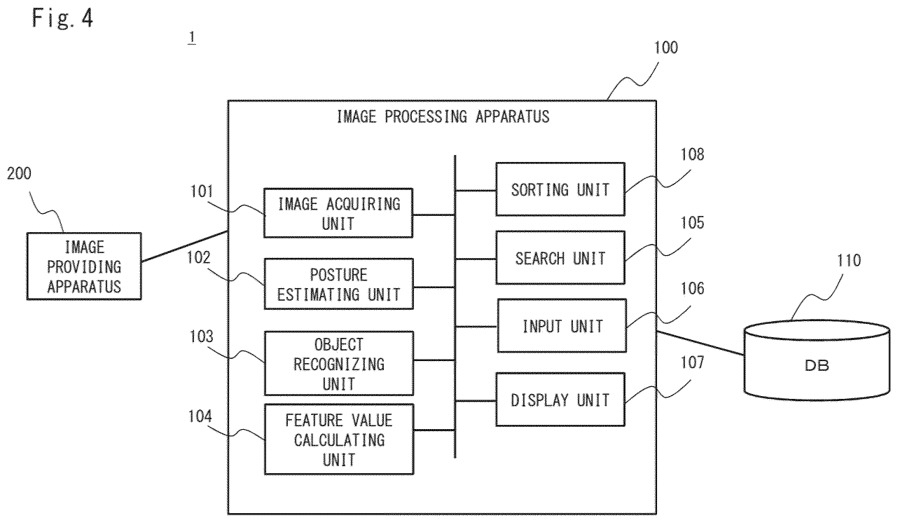

Herein, as shown in FIG. 4, the image processing apparatus 100 may include, in addition to the search unit 105 or in place of the search unit 105, a sorting unit 108 that sorts images. The sorting unit 108 sorts (put into clusters) a plurality of image stored in the database 110, based on their feature values. Like the search unit 105, the sorting unit 108 performs a similarity determination of images based on the degree of similarity between the posture feature values and between the object feature values of the images, and sorts similar images. The sorting unit 108 sorts images such that images with a high degree of similarity in terms of their posture feature values and also with a high degree of similarity in terms of their object feature values are placed in the same cluster (group). Like the search unit 105, the sorting unit 108 may sort images based on a specified query (sorting condition).

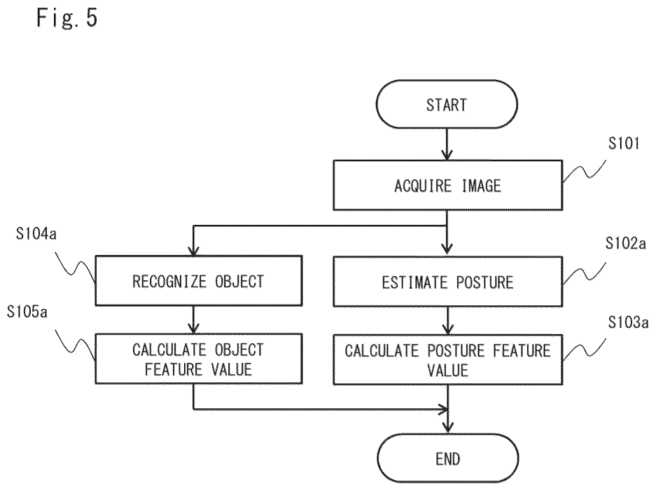

FIG. 5 shows an example of an operation of the image processing apparatus 100 according to the present example embodiment and shows a flow of a process of acquiring a search target image and storing that image into a database.

As shown in FIG. 5, the image processing apparatus 100 acquires an image from the image providing apparatus 200 (S101). The image acquiring unit 101 acquires, from the image providing apparatus 200, an image to serve as a search target for performing a search based on a person's posture and an object, and stores the acquired image into the database 110. The image acquiring unit 101 may acquire a plurality of images captured during a predetermined period from a camera or may acquire a plurality of images stored in a storage device. The following processes are performed on a plurality of acquired images.

Next, the image processing apparatus 100 estimates a person's posture based on the acquired image (S102a). For example, the acquired search target image includes a plurality of persons, and the posture estimating unit 102 detects the pose structure of each of the persons included in the image as the person's posture.

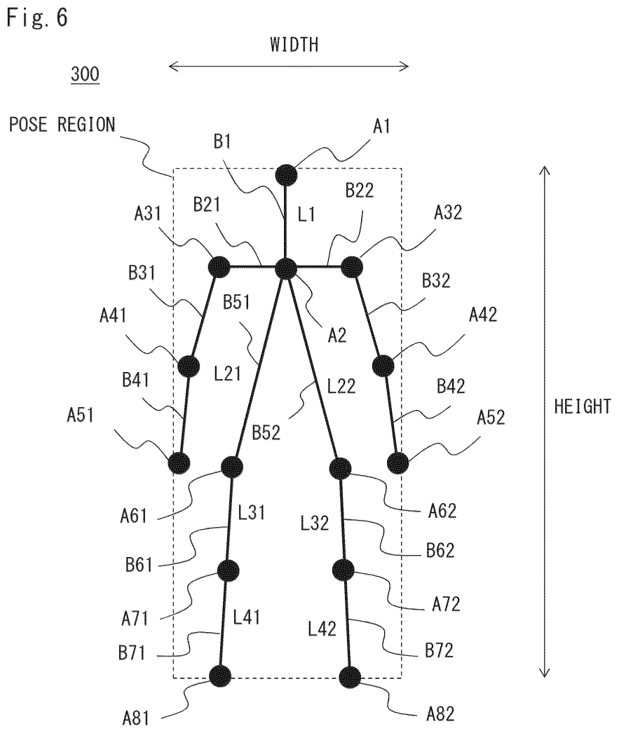

FIG. 6 shows a pose (skeleton) structure of a human model 300 detected at this stage. The posture estimating unit 102 detects the pose structure of a human model (two-dimensional pose model) 300 like the one shown in FIG. 6 from a two-dimensional image with the use of a pose estimation technique, such as OpenPose. The human model 300 is a two-dimensional model that includes key points like the person's joints and bones connecting the key points.

The posture estimating unit 102, for example, extracts a feature point that can serve as a key point from the image and, referring to information from machine learning of images of key points, detects each key point of the person. In the example shown in FIG. 6, the posture estimating unit 102 detects, as key points of the person, a head A1, a neck A2, a right shoulder A31, a left shoulder A32, a right elbow A41, a left elbow A42, a right hand A51, a left hand A52, a right hip A61, a left hip A62, a right knee A71, a left knee A72, a right foot A81, and a left foot A82. Furthermore, the posture estimating unit 102 detects, as the person's bones connecting these key points, a bone B1 connecting the head A1 and the neck A2, a bone B21 connecting the neck A2 and the right shoulder A31, a bone B22 connecting the neck A2 and the left shoulder A32, a bone B31 connecting the right shoulder A31 and the right elbow A41, a bone B32 connecting the left shoulder A32 and the left elbow A42, a bone B41 connecting the right elbow A41 and the right hand A51, a bone B42 connecting the left elbow A42 and the left hand A52, a bone B51 connecting the neck A2 and the right hip A61, a bone B52 connecting the neck A2 and the left hip A62, a bone B61 connecting the right hip A61 and the right knee A71, a bone B62 connecting the left hip A62 and the left knee A72, a bone B71 connecting the right knee A71 and the right foot A81, and a bone B72 connecting the left knee A72 and the left foot A82. The posture estimating unit 102 stores the person's pose structure detected through a pose estimation technique and the reliability of the detected pose structure into the database 110.

Next, the image processing apparatus 100 calculates the posture feature value of the estimated posture of the person (S103a). For example, when the height or the area of a pose region is to be used as the feature value, the feature value calculating unit 104 extracts a region that includes the pose structure and obtains the height (the number of pixels) or the area (the area of pixels) of the extracted region. The height or the area of the pose region can be obtained from the coordinates of an end of the extracted pose region or from the coordinates of the key point at an end. The feature value calculating unit 104 stores the obtained feature value of the pose structure into the database 110.

In the example shown in FIG. 6, the feature value calculating unit 104 extracts a pose region that includes all the bones from the pose structure of the person in erect posture. In this case, the upper end of the pose region is at the key point A1 of the head, the lower end of the pose region is at the key point A81 of the right foot or the key point A82 of the left foot, the left end of the pose region is at the key point A51 of the right hand, and the right end of the pose region is at the key point A52 of the left hand. Accordingly, the height of the pose region is obtained from the difference between the Y-coordinate of the key point A1 and the Y-coordinate of the key point A81 or A82. Furthermore, the width of the pose region is obtained from the difference between the X-coordinate of the key point A51 and the X-coordinate of the key point A52, and the area of the pose region is obtained from the height and the width of the pose region.

When a posture feature value is normalized, for example, the feature value calculating unit 104 calculates a normalization parameter, such as the number of the height pixels, based on a detected pose structure. The feature value calculating unit 104 normalizes a feature value, such as the height or the area of a pose region by the number of the height pixels.

In the example shown in FIG. 6, the feature value calculating unit 104 obtains the number of the height pixels, which corresponds to the height of the pose structure of the person in erect posture in the image, and each key point height, which corresponds to the height of each key point in the pose structure of the person in the image. The feature value calculating unit 104 may obtain the number of the height pixels by totaling the lengths of the bones from the head to the feet, among the bones in the pose structure. If the posture estimating unit 102 (pose estimation technique) does not output the top of the head and the bottom of the feet, a correction may be made as necessary through the multiplication by a constant.

Specifically, the feature value calculating unit 104 acquires the length of the bones from the person's head to the feet in the two-dimensional image and obtains the number of the height pixels. The feature value calculating unit 104 acquires the length (the number of pixels) of, of the bones shown in FIG. 6, each of the bone B1 (length L1), the bone B51 (length L21), the bone B61 (length L31), and the bone B71 (length L41), or each of the bone B1 (length L1), the bone B52 (length L22), the bone B62 (length L32), and the bone B72 (length L42). The length of each bone can be obtained from the coordinates of each key point in the two-dimensional image. The feature value calculating unit 104 calculates, as the number of the height pixels, the value obtained by multiplying the total of L1+L21+L31+L41 or the total of L1+L22+L32+L42 by a correction constant. When the values of the both can be calculated, the greater value of the two is used as the number of the height pixels. Specifically, each bone appears the longest in the image when it is imaged from the front and appears shorter as it leans in the depth direction relative to the camera. Accordingly, a longer bone is more likely to have been imaged from the front and its length is considered to be closer to the true value. Therefore, it is preferable to select the greater length value.

Herein, the number of the height pixels may be calculated through different calculation methods. For example, an average human model representing a relationship (ratio) between the length of each bone and the height in a two-dimensional image space is prepared beforehand, and the number of the height pixels may be calculated from the length of each bone detected with the use of the prepared human model.

The feature value calculating unit 104 calculates, in addition to the number of the height pixels, the height of each key point, identifies a reference point for normalization, and normalizes the height of each key point by the number of the height pixels. The feature value calculating unit 104 stores the normalized posture feature value into the database 110.

A key point height is the dimension (the number of pixels), in the height direction, from the lowermost end of a pose structure (e.g., the key point of either foot) to a given key point. As one example, a key point height is obtained from the Y-coordinate of a key point in an image. Herein, a key point height may be obtained from the length in the direction along a vertical projection axis that is based on a camera parameter. A reference point to be identified is a point that serves as a reference for expressing the relative height of a key point. A reference point may be set in advance, or a user may be able to select a reference point. A reference point preferably lies at the center of a pose structure or slightly higher than the center (higher in the top-bottom direction of the image), and the coordinates of the key point of the neck, for example, is used as a reference point. A reference point is not limited to the coordinates of the neck, and the coordinates of the head or any other key points may be used as a reference point. A reference point is not limited to being set at a key point, and any desired coordinates (e.g., the center coordinates of a pose structure) may be used as a reference point. Each key point is normalized with the use of the key point height of the key point, the reference point, or the number of the height pixels. Specifically, the feature value calculating unit 104 normalizes the relative height of a key point relative to the reference point by the number of the height pixels. Herein, in one example in which only the height direction is considered, only the Y-coordinate is extracted, and the normalization is performed with the reference point set at the key point of the neck. The normalized value turns out as a value resulting from subtracting the height of the reference point from the key point height and dividing the subtracted value by the number of the height pixels.

Following S101, the image processing apparatus 100 also recognizes an object based on the acquired image (S104a). For example, the acquired search target image includes a plurality of objects, aside from the person, and the object recognizing unit 103 recognizes the class of each of the objects included in the image. The object recognizing unit 103 detects an object region within the image with the use of an object recognition engine and recognizes the class of the object in the detected object region. The object recognizing unit 103 stores the class of the object recognized with the object recognition engine and the reliability of the recognized class into the database 110.

Next, if the image processing apparatus 100 is to calculate an object feature value, the image processing apparatus 100 calculates the object feature value of the recognized object (S105a). For example, when the size of the object region in which the object is recognized is used as the feature value, the feature value calculating unit 104 obtains, for example, the height (the number of pixels), the width (the number of pixels), or the area (the area of the pixels) of the detected rectangular object region. The feature value calculating unit 104 stores the obtained feature value of the object into the database 110. Furthermore, when the object feature value is to be normalized, the feature value calculating unit 104 normalizes the calculated size of the object region by the minimum value or the maximum value of the object region corresponding to the object class. For example, the feature value calculating unit 104 calculates the area of the object region of the object in the image and obtains, as the normalized value, the value resulting from dividing the area of the object region by the minimum value or the maximum value of the area corresponding to the recognized object class. The feature value calculating unit 104 stores the normalized object feature value into the database 110.

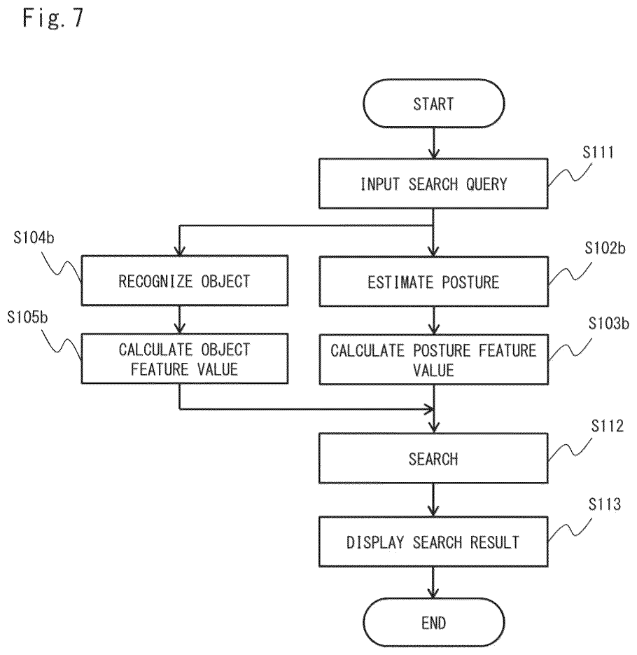

FIG. 7 shows an example of an operation of the image processing apparatus 100 according to the present example embodiment and shows a flow of a process of searching for an image similar to a search query from among the search target images stored into the database through the process shown in FIG. 5.

As shown in FIG. 7, when performing a search, a user inputs a search query into the image processing apparatus 100 (S111). The search unit 105 receives, via the input unit 106, input of the search query that is to serve as the search condition according to the user operation. For example, the display unit 107 may display a plurality of images, and the user may select an image that includes a person's posture and an object to serve as the search query (search key). Images used for a search query may be images stored in the database 110, images provided from the image providing apparatus 200, or any other images. For example, the person's posture from the posture estimation result or the object region and the object class from the object recognition result may be displayed in each image, and the images may be made selectable.

The user may select a posture and an object of a search query from a single image or may select a posture and an object of a search query from separate images. When a posture and an object of a search query are to be selected from separate images, the search unit 105 combines (merges) the selected image of the posture and the selected image of the object to generate a single search query image. Meanwhile, when a single image includes a plurality of postures and objects, the user selects one posture and one object to use as a search query. Herein, a search query is not limited to including one posture and one object and may include any number of postures and any number of objects. For example, the reliability of the posture estimation result and the reliability of the object recognition result may be displayed in each image, and a posture (pose) with a high reliability and an object with a high reliability may be displayed as being recommended as a search query. A posture and an object with a reliability higher than or equal to a predetermined value may be displayed prominently. Furthermore, a user may input the reliability of a person's posture and the reliability of an object as a search query (search condition).

The user may input a person's posture (pose) and an object to use as a search query by way of, not limited to using an image, any other methods. For example, the user may input a posture by causing each part of a pose structure to move in accordance with the user operation, or the user may input an object class. When a pose structure is input, the pose estimating process (S102b) may be omitted. Meanwhile, when an object class is input, the object recognizing process (S104b) may be omitted.

Upon receiving input of the search query, the image processing apparatus 100, as with the time of storing a search target, estimates the person's posture of the search query (S102b) and calculates the posture feature value (S103b). The posture estimating unit 102 detects the pose structure of the person (the person specified as the search query) in the search query image and outputs the detected pose structure and the reliability of the detected pose structure. The feature value calculating unit 104 calculates, for example, the height or the area of the pose structure as the feature value of the detected pose structure and normalizes the feature value such as the height or the area of the pose structure by a normalization parameter, such as the number of the height pixels.

The image processing apparatus 100, as with the time of storing a search target, also recognizes the object of the search query (S104b) and calculates the object feature value (S105b). The object recognizing unit 103 recognizes the class of the object (the object specified as the search query) in the search query image and outputs the recognized class of the object and the reliability of the recognized class. When the feature value calculating unit 104 calculates the object feature value, the feature value calculating unit 104 calculates, for example, the area of the object region as the feature value of the recognized object and normalizes the feature value, such as the area of the object region, by a normalization parameter, such as the minimum value or the maximum value of the area.

Next, the image processing apparatus 100 searches for an image based on the search query (S112). Using the person's posture and the object specified by the user as the search query, the search unit 105 searches for an image with a high degree of similarity in terms of the feature value of the person's posture and a high degree of similarity in terms of the feature value of the object from among all the images stored in the database 110 to be searched.

The search unit 105 calculates the degree of similarity between the search query and each of the search target images stored in the database 110. The search unit 105 obtains the degree of similarity between the posture feature value of a person in a search target stored in the database 110 and the calculated posture feature value of the person in the search query. Furthermore, the search unit 105 obtains the degree of similarity between the object feature value of the search target stored in the database 110 and the calculated object feature value of the search query. The search unit 105 performs a similarity determination of the images based on the obtained degree of similarity between the posture feature values and the obtained degree of similarity between the object feature values. For example, the search unit 105 locates, as a similar image, an image having each of the obtained degree of similarity in terms of the posture feature value and the obtained degree of similarity in terms of the object feature value higher than a threshold. A similarity determination may be performed with either or both of the degree of similarity between the posture feature values and the degree of similarity between the object feature values being weighted. For example, each of the obtained degree of similarity between the posture feature values and the obtained degree of similarity between the object feature values may be weighted (e.g., 1.0, 0.8, etc.), and a similarity determination may be performed by comparing the total value of the weighted degrees of similarity against a threshold. Furthermore, the threshold against which each degree of similarity is determined may be varied depending on the weight.

Furthermore, the reliability of posture estimation may be reflected onto the degree of similarity between the posture feature values, and the reliability of object recognition may be reflected onto the degree of similarity between the object feature values. For example, the degree of similarity between the reliability of the posture of a person in a search target and the reliability of the posture of the person in the search query may be obtained, and the degree of similarity between the reliability of an object in the search target and the reliability of the object in the search query may be obtained. Such a degree of similarity may be obtained with the feature values being weighted by each of the reliabilities. For example, the posture feature value of the person in the search target is multiplied by the reliability of that posture, the posture feature value of the person in the search query is multiplied by the reliability of that posture, and the degree of similarity between the posture feature values is obtained with the use of the multiplied results. The object feature value of the search target is multiplied by the reliability of that object, the object feature value of the search query is multiplied by the reliability of that object, and the degree of similarity between the object feature values is obtained with the use of the multiplied results.

Meanwhile, each reliability may be compared against a threshold, and only the feature value whose reliability exceeds the threshold may be used to calculate the degree of similarity. For example, when the reliability of recognizing the person and the object in the search query and the person in the search target exceed a threshold but the reliability of recognizing the object in the search target falls below the threshold, a search may be performed based only on the degree of similarity between the feature values of the persons' postures, without the degree of similarity between the objects taken into account.

Next, the image processing apparatus 100 displays the result of searching for an image (S113). The search unit 105 acquires the image (similar image) obtained as the search result from the database 110 and displays the obtained image on the display unit 107. The search unit 105 may display the similar image and the search query image and display the person's posture (pose structure), the person region (pose region), the object class, and the object region in each of the images. When there are a plurality of similar images, the manner in which the images are displayed may be varied between the images in accordance with the degree of similarity. The images may be arranged and displayed in the order of the higher degree of similarity, or an image with a high degree of similarity may be displayed prominently.

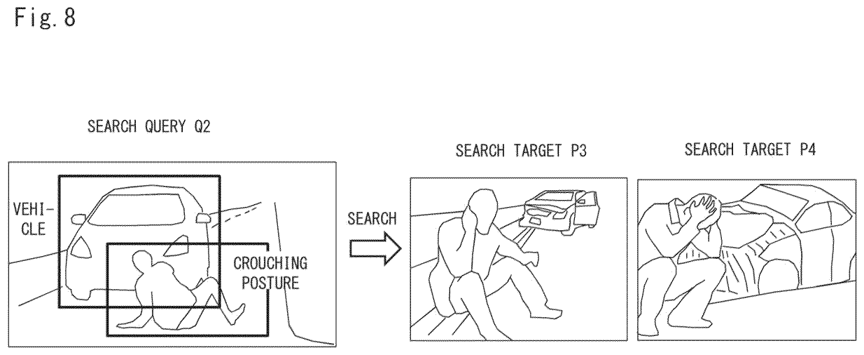

FIG. 8 shows a specific example of an image search performed by the image processing apparatus 100 according to the present example embodiment. As shown in FIG. 8, when a scene (image) of a traffic accident is to be found, for example, the person in crouching posture and the vehicle captured in the image of a traffic accident are selected and input to the image processing apparatus 100 as a search query Q2. Then, the image processing apparatus 100 estimates the pose of the crouching posture of the person from the image of the search query Q2 and recognizes the vehicle as the object class from the image of the search query Q2. The image processing apparatus 100 searches for, from among the search target images in the database 110, an image that includes a posture with a high degree of similarity with the pose of the crouching posture and an object of a class with a high degree of similarity with the vehicle. As a result, an image including a person in crouching posture and a vehicle, like a search target P3 or a search target P4, can be located, and thus a desired scene of a traffic accident can be found.

As described above, according to the present example embodiment, a similar image is searched for with the posture feature value of a person and the object feature value of an object in an image used as a search query. In other words, for a search target image, the posture of a person is estimated, and the posture feature value is calculated. Also, an object is recognized, and the object feature value is calculated. Furthermore, for the search query as well, the posture of the person is estimated, and the posture feature value is calculated. Also, the object is recognized, and the object feature value is calculated. Based on the degree of similarity between the posture feature values and the degree of similarity between the object feature values, an image similar to the search query is located from among the search target images. With this configuration, an image having a similar posture and a similar object can be located, and thus an image closer to an image (scene) to be found can be found.

### Second Example Embodiment

Now, a second example embodiment will be described with reference to some drawings. In the example described according to the present example embodiment, a similar image is searched for with, as compared to the first example embodiment, the additional use of a feature representing a relationship between a person and an object.

According to the first example embodiment, a similar image is searched for through a combination of a feature of a person's posture and a feature of an object. This configuration makes it possible to search for an image with a similar posture of a person and a similar object, as described above. Meanwhile, even with the first example embodiment, there may be a case in which an image close to an image that the user wants to find cannot be located.

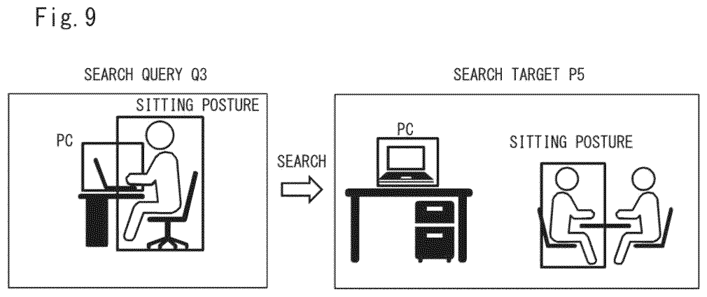

For example, as shown in FIG. 9, when a scene showing a person operating a PC is to be searched for, the person in sitting posture and the PC in the image are selected and used as a search query Q3. In this case, according to the first example embodiment, since an image with a similar posture of a person and a similar object is searched for, an image with a person in sitting posture and a PC is located. As a result, not only an image with a person operating a PC but also an image including a person sitting away from a PC, as in a search target P5, is located. In other words, according to the first example embodiment, an image including a posture and an object that are accidentally similar can be detected. Accordingly, the present example embodiment allows for an image search with the relationship between a person and an object taken into account.

An image processing apparatus 100 has a configuration similar to that according to the first example embodiment. According to the present example embodiment, the image processing apparatus 100 performs a similarity determination based on the relationship between a person and an object in each image and searches for a similar image.

The feature value calculating unit 104 calculates, in addition to the posture feature value of a person and the object feature value of an object, a relationship feature value concerning a relationship between the person and the object. The feature value calculating unit 104 calculates the posture feature value of a person, the object feature value of an object, and a relationship feature value of the person and the object in a search target image, and calculates the posture feature value of a person, the object feature value of an object, and a relationship feature value between the person and the object in a search query image.

The search unit 105 performs a similarity determination based on the degree of similarity between the posture feature values, the degree of similarity between the object feature values, and the degree of similarity between the relationship feature values. The search unit 105 may perform a similarity determination based on the weight of the degree of similarity between the posture feature values, of the degree of similarity between the object feature values, and of the degree of similarity between the relationship feature values.

The relationship feature value according to the present example embodiment includes, for example, a distance relationship feature value that is based on the distance between a person and an object, an orientation relationship feature value that is based on the orientation of a person and of an object, and a positional relationship feature value that is based on the positional relationship of a person and an object. The feature value calculating unit 104 may calculate any one of the distance relationship feature value, the orientation relationship feature value, and the positional relationship feature value, or may calculate any combinations of the relationship feature values. Examples of calculating these relationship feature values are illustrated below.

### <Distance Relationship Feature Value>

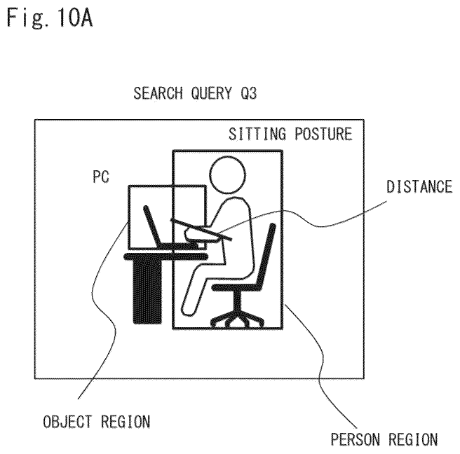

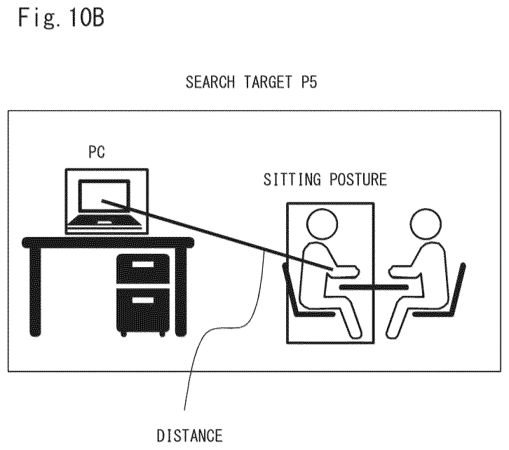

The feature value calculating unit 104 extracts the distance between a person and an object from a search query image or a search target image and uses the extracted distance for the feature value (distance relationship feature value). FIGS. 10A and 10B show an example of extracting the distance to be used for the distance relationship feature value. FIG. 10A shows an example of extracting the distance in the search query Q3 shown in FIG. 9, and FIG. 10B shows an example of extracting the distance in the search target P5 shown in FIG. 9.

The distance between a person and an object to be used for the distance relationship feature value is, for example, the distance between the person region of the person whose posture is estimated and the object region of the recognized object. A person region is a rectangular region that includes a person whose posture is estimated and is, for example, a pose region that includes the pose of the person whose pose is estimated in posture estimation as described according to the first example embodiment. A person region may be a posture region that includes a person whose posture is detected when the posture is detected through any other methods or may be a person region that includes a recognized person when the person is recognized through image recognition. Meanwhile, an object region is a rectangular region that includes a recognized object and is an object region that includes an object detected through object recognition.

The feature value calculating unit 104 obtains the distance (the number of pixels) along a line connecting the coordinates of a point included in a person region in an image and the coordinates of a point included in an object region in the image. In the example shown in FIGS. 10A and 10B, the feature value calculating unit 104 obtains the distance between the center point of the person region and the center point of the object region. In other words, the feature value calculating unit 104 obtains the coordinates of the center point of the person region from the coordinates of each vertex of the rectangular person region, obtains the coordinates of the center point of the object region from the coordinates of each vertex of the rectangular object region, and obtains the distance between the center point of the person region and the center point of the object region.

The feature value calculating unit 104 may obtain the distance between the closest points of a person region and of an object region. For example, the feature value calculating unit 104 may obtain the point, among all the points in the person region, that is closest to the object region and the point, among all the points in the object region, that is closest to the person region and may thus obtain the distance between the closest points, or the feature value calculating unit 104 may obtain the distance between the closest vertices of the vertices of the person region and of the vertices of the object region. Furthermore, the feature value calculating unit 104 may obtain the distance between the farthest points of the person region and of the object region. For example, the feature value calculating unit 104 may obtain the point, among all the points in the person region, that is farthest from the object region and the point, among all the points in the object region, that is farthest from the person region and may thus obtain the distance between the farthest points, or the feature value calculating unit 104 may obtain the distance between the farthest vertices of the vertices of the person region and of the vertices of the object region. Furthermore, the feature value calculating unit 104 may obtain the distance between a vertex of the person region and a vertex of the object region.

The feature value calculating unit 104 may normalize the obtained distance between a person and an object by a normalization parameter and use the normalized distance as the feature value. Examples of those that may be used as a normalization parameter include the image size of a search query or a target image, the height of a person whose posture is estimated (the number of the height pixels described according to the first example embodiment), the mean of the size of a person region and the size of an object region (height, width, area, etc.), and the Intersection over Union (IoU) indicating the overlap of a person region and an object region. The feature value calculating unit 104 normalizes the distance between a person and an object by dividing the distance by a normalization parameter.

With the distance relationship feature value described above, the feature value indicating the feature of the relationship between the object and the person observed when the person is sitting near the PC as in the search query Q3 shown in FIG. 10A or the feature of the relationship between the object and the person observed when the person is sitting away from the PC as in the search target P5 shown in FIG. 10B can be obtained. Accordingly, performing a similarity determination based on the distance relationship feature value can determine that the search query Q3 and the search target P5 are not similar.

### <Orientation Relationship Feature Value>

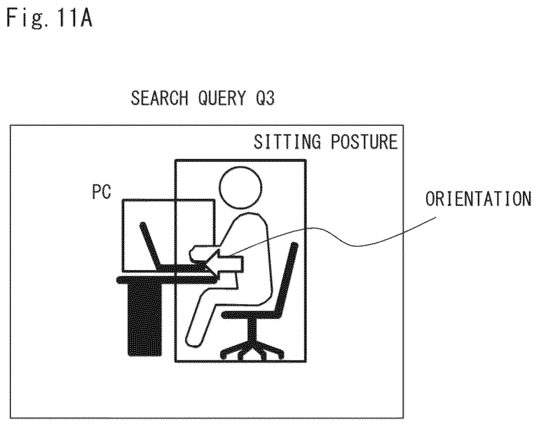

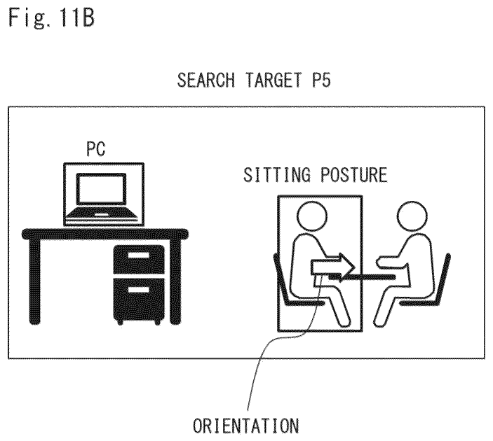

The feature value calculating unit 104 obtains the orientation of a person from a search query image or a search target image and uses the obtained orientation for the feature value (orientation relationship feature value). FIGS. 11A and 11B show an example of extracting the orientation of a person to be used for the orientation relationship feature value. FIG. 11A shows an example of extracting the orientation of the person in the search query Q3 shown in FIG. 9, and FIG. 11B shows an example of extracting the orientation of the person in the search target P5 shown in FIG. 9.

The orientation of a person to be used for the orientation relationship feature value may be extracted, for example, from the posture of the person estimated through the posture estimation of the person, as shown in FIGS. 11A and 11B. Specifically, the front, the back, the right, and the left of a person can be detected from the estimated pose structure, and thus the front direction of the person in the image is extracted as the orientation of the person. The orientation of a person can be extracted in a similar manner when the posture is estimated through any other methods, not limited to through a pose structure of the person. Furthermore, the orientation of a person may be extracted from the orientation of the face of the person, not limited to extracting from the posture of the person.

For example, the face of a person is recognized from an image, and the orientation of the recognized face is used as the orientation of the person. Furthermore, the orientation of a person may be extracted from the line of sight of the person. For example, the line of sight of a person is recognized from an image, and the direction of the recognized line of sight is used as the orientation of the person.

The feature value calculating unit 104 obtains, for example, the degree of similarity (relationship) between the extracted orientation of a person and the direction of a line connecting the person and an object as the feature value. In one example, the feature value calculating unit 104 obtains the cosine similarity between the line connecting a person and an object and the orientation of the person. As with the case of the distance relationship feature value, the line connecting a person and an object may be the line connecting the centers of the respective rectangles or the line connecting any points in the respective rectangles.

When the orientation of an object can be detected from an image through object recognition, the detected orientation of the object may be used for the feature value. For example, when a PC is recognized as an object, the orientation of the screen of the PC may be used as the orientation of the object. When a vehicle is recognized as an object, the front direction of the vehicle may be used as the orientation of the object. In such cases, the degree of similarity (relationship) between the extracted orientation of the object and the extracted orientation of the person may be obtained as the feature value.

With the orientation relationship feature value described above, the feature value indicating the feature of the relationship between the object and the person observed when the person is sitting facing the PC as in the search query Q3 shown in FIG. 11A or the feature of the relationship between the object and the person observed when the person is sitting facing away from the PC as in the search target P5 shown in FIG. 11B can be obtained. Accordingly, performing a similarity determination based on the orientation relationship feature value can determine that the search query Q3 and the search target P5 are not similar.

### <Positional Relationship Feature Value>

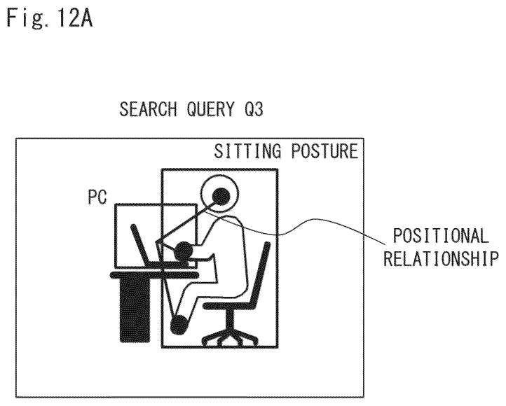

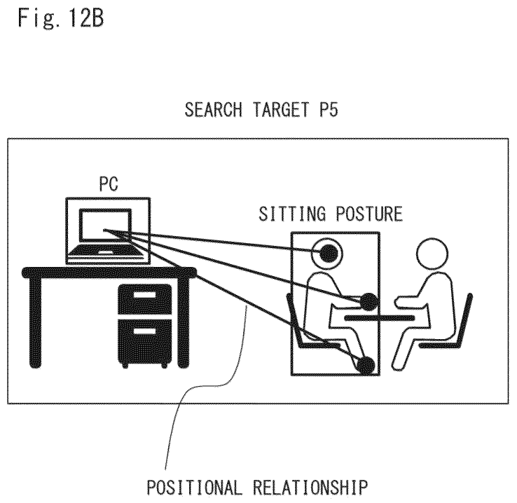

The feature value calculating unit 104 obtains the positional relationship of a person and an object from a search query image or a search target image and uses the obtained positional relationship for the feature value (positional relationship feature value). FIGS. 12A and 12B show an example of extracting the positional relationship to be used for the positional relationship feature value. FIG. 12A shows an example of extracting the positional relationship in the search query Q3 shown in FIG. 9, and FIG. 12B shows an example of extracting the positional relationship in the search target P5 shown in FIG. 9.

The positional relationship to be used for the positional relationship feature value can be extracted, for example, from a plurality of distances between a person whose posture is estimated and a recognized object. Specifically, the positional relationship between one point in one of a person whose posture is estimated and an estimated object and a plurality of points in the other of the person whose posture is estimated and the estimated object is used. For example, the one-to-many positional relationship between a plurality of points in a person whose posture is estimated and one point in an estimated object may be used, or the one-to-many positional relationship between one point in a person whose posture is estimated and a plurality of points in an estimated object may be used. Herein, the positional relationship between a plurality of points in one region and a plurality of point in the other region may be used.

The feature value calculating unit 104 obtains the distance along a plurality of lines connecting a person region and an object region in an image. In the example shown in FIGS. 12A and 12B, the feature value calculating unit 104 obtains the distance between one point in the object region and a plurality of points in the person region. As with the case of the distance relationship feature value described above, the one point in the object region may be the center point of the object region or may be any point in the object region. When an object can be recognized from an image, a point of interest, such as the screen of a PC, may be used as the one point of the object. A plurality of points in the person region may be articulation points (key points, sites) of the person included in the recognized pose (posture) of the person. In FIGS. 12A and 12B, as one example, three points including the head (e.g., key point A1), the wrist (key point A51 or A52), and the ankle (key point A81 or A82) of the person are extracted. Points of sites such as the head, the wrist, or the ankle recognized through image recognition, not limited to the use of a recognized pose structure, may be extracted.

The feature value calculating unit 104 calculates the feature value based on an obtained plurality of distances between a person region and an object region, the values obtained by normalizing the plurality of distances (normalization similar to that of the distance relationship feature value), or a plurality of vectors including the distances and the orientations. After the calculation of the feature value, the search unit 105 may use, in a similarity determination of the feature value of the query image and the feature value of the search target image, for example, the degree of similarity between the plurality of distances, the degree of similarity between the normalized values of the plurality of distances, or the degree of similarity between the plurality of vectors (Lk distance (Euclidean distance or Manhattan distance), cosine similarity) as the degree of similarity. The search unit 105 may determine the distance or the degree of similarity with regard to the feature value of the query image and the feature value of the search target image. For example, the search unit 105 may perform a similarity determination based on the plurality of distances, the normalized values of the plurality of distances, the distances (Euclidean distance or Manhattan distance) between the plurality of vectors, or the degree of similarity (cosine similarity or the like).

The feature value calculating unit 104 may use, as the feature value, the order of the points in a person or an object according to the calculated magnitudes of the plurality of distances. For example, when the distances between one point in an object and a plurality of articulation points are used, the order of the proximity of the articulation points may be used as the feature value. For example, in the search query Q3 shown in FIG. 12A, the distances from the articulation points of the person to the PC are in the relationship of wrist<ankle<head, and thus the feature value is set as (1 wrist, 2 ankle, 3 head). In the search target P5 shown in FIG. 12B, the distances from the articulation points of the person to the PC are in the relationship of head<wrist<ankle, and thus the feature value is set to (1 head, 2 wrist, 3 ankle).

With the positional relationship feature value described above, the feature value indicating the feature of the relationship between the object and the person observed when the person is sitting near the PC with his or her hands on the PC as in the search query Q3 shown in FIG. 12A or the feature of the relationship between the object and the person observed when the person is sitting away from the PC with his or her hands away from the PC as in the search target P5 shown in FIG. 12B can be obtained. Accordingly, performing a similarity determination based on the positional relationship feature value can determine that the search query Q3 and the search target P5 are not similar.

Furthermore, the distance relationship feature value, the orientation relationship feature value, and the positional relationship feature value may be feature values of the distance, the orientation, and the positional relationship in the three-dimensional space. A person's posture or the positional relationship between a person and an object in the three-dimensional space (distance, orientation, positional relationship) may be estimated with the use of a camera parameter used to acquire a search query or a search target image, and each of the feature values may be calculated through the methods described above. In this case, the image processing apparatus 100 may include a camera parameter acquiring unit that acquires a camera parameter from, for example, a camera that captures an image. For example, as with the first example embodiment, an image of an object whose length or position is known beforehand may be captured with a camera, and a camera parameter may be obtained from the image.

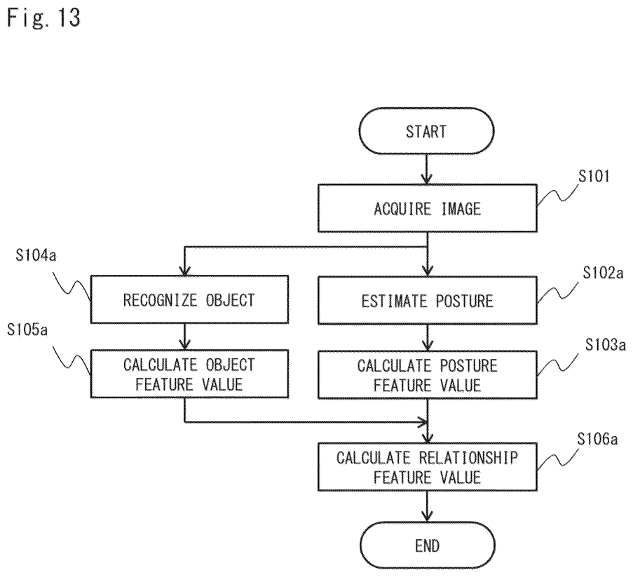

FIG. 13 shows an example of an operation of the image processing apparatus 100 according to the present example embodiment and shows a flow of a process of acquiring a search target image and storing that image into a database.

As with the first example embodiment, as shown in FIG. 13, upon acquiring a search target image (S101), the image processing apparatus 100 estimates the posture of a person in the acquired image (S102a) and calculates the posture feature value (S103a). The image processing apparatus 100 also recognizes an object in the acquired image (S104a) and calculates the object feature value (S105a).

According to the present example embodiment, after S103a and S105a, the image processing apparatus 100 calculates a relationship feature value concerning the relationship between the person and the object in the acquired image (S106a). The feature value calculating unit 104 calculates the relationship feature value based on the relationship between the person whose posture is estimated from the search target image at S102a and the object recognized at S104a. As the relationship feature value, the feature value calculating unit 104 calculates, for example, the distance relationship feature value, the orientation relationship feature value, or the positional relationship feature value, as described above. The feature value calculating unit 104 stores the calculated relationship feature value into the database 110.

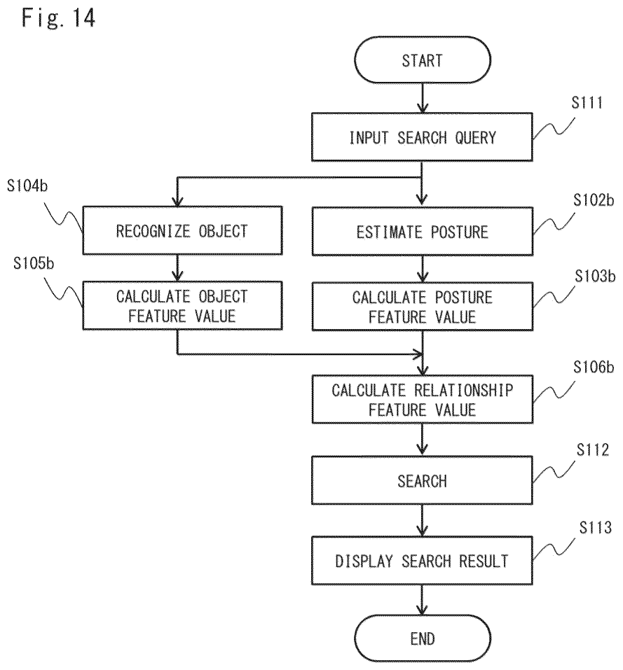

FIG. 14 shows an example of an operation of the image processing apparatus 100 according to the present example embodiment and shows a flow of a process of searching for an image similar to a search query from among the search target images stored into the database through the process shown in FIG. 13.

As with the first example embodiment, as shown in FIG. 14, upon receiving input of a search query (S111), the image processing apparatus 100 estimates the posture of the person in the search query (S102b) and calculates the posture feature value (S103b). The image processing apparatus 100 also recognizes the object in the search query (S104b) and calculates the object feature value (S105b).

According to the present example embodiment, after S103b and S105b, the image processing apparatus 100 calculates a relationship feature value concerning the relationship between the person and the object in the search query (S106b). The feature value calculating unit 104 calculates the relationship feature value based on the relationship between the person whose posture is estimated from the search query image at S102b and the object recognized at S104b. As with the time of storing the search target, as the relationship feature value, the feature value calculating unit 104 calculates, for example, the distance relationship feature value, the orientation relationship feature value, or the positional relationship feature value.

Next, the image processing apparatus 100 searches for an image based on the search query (S112). The search unit 105 calculates the degree of similarity between the posture feature value of the person in the search query and the posture feature value of the person in the search target, calculates the degree of similarity between the posture feature value of the object in the search query and the object feature value of the object in the search target, and further calculates the degree of similarity between the relationship feature value of the person and the object in the search query and the relationship feature value of the person and the object in the search target. The search unit 105 performs a similarity determination of the images based on the obtained degree of similarity between the posture feature values, the obtained degree of similarity between the object feature values, and the obtained degree of similarity between the relationship feature values. For example, the search unit 105 locates, as a similar image, an image with each of the obtained degree of similarity in terms of the posture feature value, the obtained degree of similarity in terms of the object feature value, and the obtained degree of similarity in terms of the relationship feature values higher than a threshold. The search unit 105 may perform a similarity determination with any of the degree of similarity between the posture feature values, the degree of similarity between the object feature values, and the degree of similarity between the relationship feature values or a selected degree of similarity being weighted. For example, each of the obtained degree of similarity between the posture feature values, the obtained degree of similarity between the object feature values, and the obtained degree of similarity between the relationship feature values may be weighted (e.g., 1.0, 0.8, 0.5, etc.), and the search unit 105 may perform a similarity determination by comparing the total value of the weighted degrees of similarity against a threshold. The threshold against which each degree of similarity is determined may be varied depending on the weight.

Furthermore, the search unit 105 may calculate, as the degree of similarity between the relationship feature values, the degree of similarity between the distance relationship feature values, the degree of similarity between the orientation relationship feature values, or the degree of similarity between the positional relationship feature values (any one of the degrees of similarity if any of the feature values is calculated). The search unit 105 performs a similarity determination of the images with the obtained degree of similarity between the distance relationship feature values, the obtained degree of similarity between the orientation relationship feature values, or the obtained degree of similarity between the positional relationship feature values taken into account. For example, the search unit 105 determines whether each of the degree of similarity between the distance relationship feature values, the degree of similarity between the orientation relationship feature values, and the degree of similarity between the positional relationship feature values is greater than a threshold. The search unit 105 may perform a similarity determination with any of the degree of similarity between the distance relationship feature values, the degree of similarity between the orientation relationship feature values, and the degree of similarity between the positional relationship feature values or a selected degree of similarity being weighted. For example, each of the obtained degree of similarity between the distance relationship feature values, the obtained degree of similarity between the orientation relationship feature values, and the obtained degree of similarity between the positional relationship feature values may be weighted, and the search unit 105 may perform a similarity determination by comparing the total value of the weighted degrees of similarity against a threshold. The threshold against which each degree of similarity is determined may be varied depending on the weight.

As described above, according to the present example embodiment, a similar image is searched for with the use of, in addition to the configuration of the first example embodiment, a relationship feature value concerning the relationship between a person and an object. Furthermore, as the relationship feature value, a feature value concerning the distance between the person and the object, the orientation of the person and of the object, or the positional relationship between the person and the object is used. With this configuration, an image that is similar in terms of the relationship between the person and the object, as well as in terms of the person's posture and the object, can be searched for, and an image even closer to an image (scene) to be found can be located.

### Third Example Embodiment

Now, a third example embodiment will be described with reference to some drawings. In the example described according to the present example embodiment, a similar image is searched for through, additionally, a combination with HOI detection, as compared to the first or the second example embodiment.

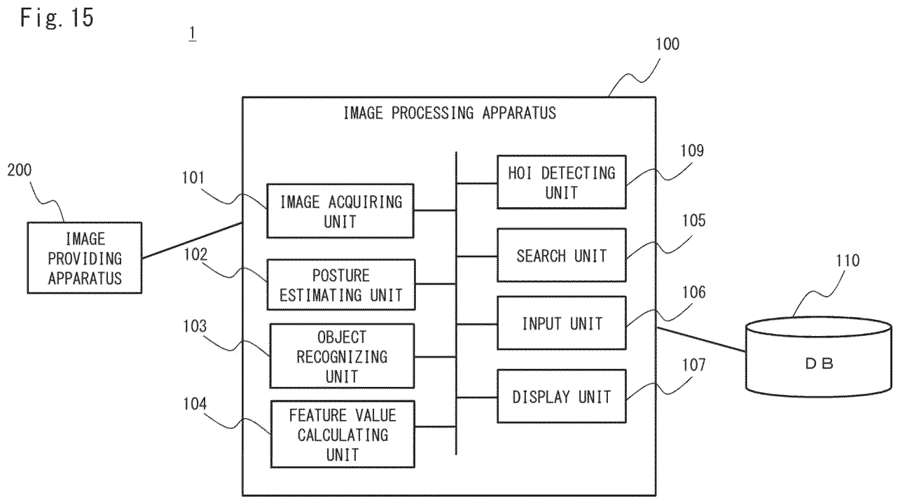

FIG. 15 shows a configuration of an image processing apparatus 100 according to the present example embodiment. As shown in FIG. 15, the image processing apparatus 100 according to the present example embodiment includes an HOI detecting unit 109, in addition to the components according to the first or the second example embodiment.

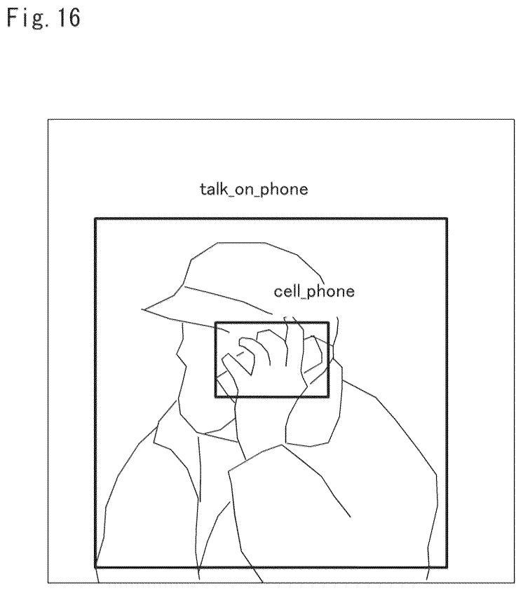

The HOI detecting unit 109 performs HOI detection described in Non Patent Literature 1. The HOI detecting unit 109 detects, through HOI detection, a pair containing a person and an object bearing an association with each other from an image and a verb for the person (e.g., an action such as a person's kicking from the person and a soccer ball). FIG. 16 shows an example of detection through HOI detection. In the example shown in FIG. 16, a pair containing the person and the cellular phone (object) bearing an association with each other is detected from the image, and a verb indicating that the person is talking on the phone is detected. The HOI detecting unit 109 also generates an association score (reliability) of the verb for the person detected through the HOI detection. As the association score is higher, the likelihood that the detected verb for the person (including the pair containing the person and the object) is correct is higher.

Herein, a pair containing a person and an object bearing an association with each other and a verb for the person may be detected through a detection technique that uses other machine learning, not limited to HOI detection. For example, detection similar to HOI detection may be performed through machine learning of images of pairs containing a person and an object bearing an association with each other with the use of labels of verbs for the persons.

The HOI detecting unit 109 may acquire the result of HOI detection obtained in advance through HOI detection of an image from an external apparatus (the image providing apparatus 200, the database 110, the input unit 106, or the like). The search unit 105 may perform a similarity determination with the use of the result of HOI detection acquired from the outside or may perform a similarity determination with the use of the result of HOI detection detected by the HOI detecting unit 109 through an HOI detection process. For example, the search unit 105 may perform a similarity determination of a first image and a second image based on the result of HOI detection obtained through an HOI detection process performed based on the first image and the result, acquired from the outside, of HOI detection of the second image.

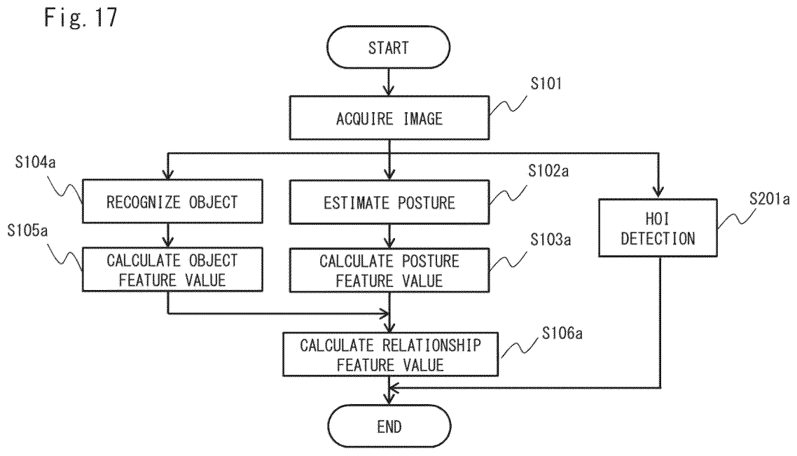

FIG. 17 shows an example of an operation of the image processing apparatus 100 according to the present example embodiment and shows a flow of a process of acquiring a search target image and storing that image into a database. Although an example in which the present example embodiment is applied to the operation according to the second example embodiment is shown herein, the present example embodiment may be applied to the operation according to the first example embodiment.

As with the second example embodiment, as shown in FIG. 17, upon acquiring a search target image (S101), the image processing apparatus 100 estimates the posture of a person in the acquired image (S102a) and calculates the posture feature value (S103a). The image processing apparatus 100 also recognizes an object in the acquired image (S104a) and calculates the object feature value (S105a). The image processing apparatus 100 further calculates a relationship feature value between the person and the object in the acquired image (S106a).

Furthermore, according to the present example embodiment, after acquiring the image (S101), the image processing apparatus 100 performs HOI detection based on the acquired image (S201a). The HOI detecting unit 109 performs HOI detection on the acquired image, detects a pair containing the person and the object bearing an association with each other and a verb (action) for the person, and generates the association score (reliability) of the detected verb for the person. The HOI detecting unit 109 stores the detected pair of the person and the object, the verb for the person, and the association score into the database 110.

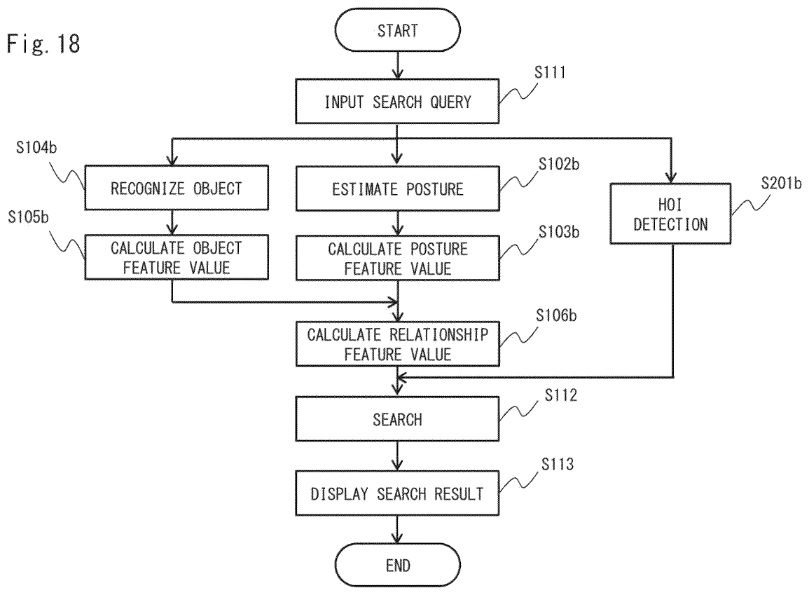

FIG. 18 shows an example of an operation of the image processing apparatus 100 according to the present example embodiment and shows a flow of a process of searching for an image similar to a search query from among the search target images stored into the database through the process shown in FIG. 17. Although an example in which the present example embodiment is applied to the operation according to the second example embodiment is shown herein, the present example embodiment may be applied to the operation according to the first example embodiment.

As with the second example embodiment, as shown in FIG. 18, upon receiving input of a search query (S111), the image processing apparatus 100 estimates the posture of the person in the search query (S102b) and calculates the posture feature value (S103b). The image processing apparatus 100 also recognizes the object in the search query (S104b) and calculates the object feature value (S105b). The image processing apparatus 100 further calculates a relationship feature value of the person and the object in the search query (S106b).

Furthermore, according to the present example embodiment, after receiving input of the search query (S111), the image processing apparatus 100 performs HOI detection (S201b). As with the time of storing the search target, the HOI detecting unit 109 performs HOI detection on the search query image, detects a pair containing the person and the object bearing an association with each other and a verb for the person, and generates the association score of the detected verb for the person.

Next, the image processing apparatus 100 searches for an image based on the search query (S112). The search unit 105 searches for a similar image through a combination of a posture-object search (first similarity determination) that uses the posture estimation results and the object recognition results obtained at S102a to S106b and S102b to S106b and HOI detection (second similarity determination) that uses the HOI detection results obtained at S201a and S201b.

A posture-object search is the search method described in the first or the second example embodiment. Specifically, with regard to a search target image and a search query image, the degree of similarity between the posture feature values of the persons and the degree of similarity between the object feature values of the objects (and additionally the degree of similarity between the relationship feature values) are obtained, a similarity determination is performed based on the obtained degrees of similarity, and a similar image is thus searched for.

In HOI detection, the degree of similarity between the HOI detection result of a search target image and the HOI detection result of a search query image is obtained, a similarity determination is performed based on the obtained degree of similarity, and a similar image is thus searched for. In other words, a similarity determination is performed based on the degree of similarity, obtained through HOI detection, between the pairs of persons and objects bearing an association with each other and between the verbs for the persons, and a similar image is thus searched for.

The search unit 105 may perform a search by selecting either of a posture-object search and an HOI search. For example, the search unit 105 performs a search by selecting either of a posture-object search and HOI detection based on the association score (reliability) of the HOI detection result. When the association score of the HOI detection result of the search query is higher than a threshold, that is, when a verb with a high reliability is estimated from the search query image, the search unit 105 searches for a similar image through the HOI search. Meanwhile, when the association score of the HOI detection result of the search query is lower than the threshold, that is, when a verb with a high reliability is not estimated from the search query image, the search unit 105 searches for a similar image through the posture-object search.

The search unit 105 may perform a search with the use of both a posture-object search and a HOI search. For example, the search unit 105 performs a search with a posture-object search and an HOI search being weighted based on the association score of the HOI search result. When the association scores of the HOI detection results of a search query and of a search target are higher than a threshold, that is, when a verb with a high reliability is estimated from each of a search query image and a search target image (phone conversation: 0.8, etc.), the search unit 105 searches for a similar image with the HOI search being weighted. Meanwhile, when the association scores of the HOI detection results of a search query and of a search target are lower than the threshold, that is, when a verb with a high reliability is not estimated from either of a search query image and a search target image (pick up: 0.03, etc.), the search unit 105 searches for a similar image with the posture-object search being weighted.

Either of a posture-object search and an HOI search may be selected, or a posture-object search and an HOI search may be weighted, based on, not limited to the association score of the HOI search result, the reliabilities of posture estimation and of object recognition (e.g., the mean value of the reliability of posture estimation and the reliability of object recognition). Either of a posture-object search and an HOI search may be selected, or a posture-object search and an HOI search may be weighted, in accordance with the result of comparing the association score of the HOI search result and the reliabilities of posture estimation and of object recognition.

A user may manually adjust the weight of a posture-object search and of an HOI search. For example, when a posture-object search and an HOI search are to be weighted, the degree of similarity used in the posture-object search and the degree of similarity used in the HOI search may be weighted. The degree of similarity between the posture feature values of persons and the degree of similarity between the object feature values (additionally the degree of similarity between the relationship feature values) may be weighted, and the degree of similarity between the pairs of persons and objects bearing an association with each other and the degree of similarity between the verbs for the persons in HOI detection may be weighted. Then, an image with any of the weighted degrees of similarity greater than a threshold may be located, or an image with a total of the weighted degrees of similarity greater than a threshold may be located.

As described above, according to the present example embodiment, a similar image is searched for with the use of the detection result of HOI detection, in addition to the configuration of the first or the second example embodiment. As an image is searched for with the use of a posture-object search according to the first or the second example embodiment and an HOI search through HOI detection, a similar image can be found effectively.

HOI detection can detect only events that are in the training data. For example, if training is not done with the verb “traffic accident,” its similar image cannot be found. Furthermore, since no posture is recognized in HOI detection, the degree of similarity can be determined erroneously. For example, when a person and a soccer ball are near each other, the person can be determined to be kicking the soccer ball even when the person is not kicking the soccer ball. Meanwhile, with HOI detection, a search can be performed with the searches narrowed down to the pairs containing a person and an object bearing an association with each other while the pairs containing a person and an object bearing no association with each other are excluded. Therefore, as a search is performed with either of a posture-object search and an HOI search being weighted or a posture-object search and an HOI search being weighted in accordance with, for example, the reliability of the HOI detection, a similar image can be found with high accuracy while utilizing the advantages of the HOI detection and compensating for the disadvantages of the HOI detection.

It is to be noted that the present disclosure is not limited by the foregoing example embodiments, and modifications can be made, as appropriate, within the scope that does not depart from the technical scope and spirit.

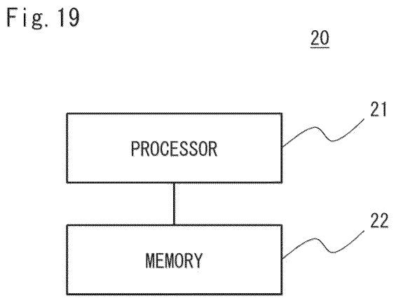

Each of the components according to the foregoing example embodiments may be constituted by hardware or software or both. Each of the components may be constituted by a single piece of hardware or software or by a plurality of pieces of hardware or software. Each of the apparatuses or devices and of the functions (processes) may be realized by a computer 20 that includes a processor 21, such as a central processing unit (CPU), and a memory 22 serving as a storage device, as illustrated in FIG. 19. For example, a program for implementing a method (image processing method) according to an example embodiment may be stored in the memory 22, and each of the functions may be realized as the processor 21 executes the program stored in the memory 22.

Such programs include a set of instructions (or software codes) that, when loaded onto a computer, causes the computer to execute one or more functions described according the example embodiments. The programs may be stored in a non-transitory computer-readable medium or in a tangible storage medium. As some non-limiting examples, a computer-readable medium or a tangible storage medium includes a random-access memory (RAM), a read-only memory (ROM), a flash memory, a solid-state drive (SSD), or other memory technologies; a CD-ROM, a digital versatile disc (DVD), a Blu-ray (registered trademark) disc, or other optical disc storages; and a magnetic cassette, a magnetic tape, a magnetic disk storage, or other magnetic storage devices. The programs may be transmitted via a transitory computer-readable medium or via a communication medium. As some non-limiting examples, a transitory computer-readable medium or a communication medium includes an electric, optical, or acoustic propagation signal or a propagation signal of any other form.

Thus far, the present disclosure has been described with reference to example embodiments, but the foregoing example embodiments do not limit the present disclosure. Various modifications that a person skilled in the art can appreciate within the scope of the present disclosure can be made to the configurations and details of the present disclosure.

Part or the whole of the foregoing example embodiments can be expressed also as in the following supplementary notes, which are not limiting.

### Supplementary Note 1

An image processing system comprising:
posture estimation acquiring means for acquiring an estimation result of estimating a posture of a person included in a first image and a person included in a second image;
object recognition acquiring means for acquiring a recognition result of recognizing an object, other than the persons, included in the first image and an object included in the second image; and
similarity determining means for performing a similarity determination of the similarity of the first image to the second image based on the estimation results of the postures of the persons and the recognition results of the objects.

### Supplementary Note 2

The image processing system according to Supplementary note 1, wherein the similarity determining means performs the similarity determination based on a degree of similarity between posture feature values that are based on the estimation results of the postures of the persons and a degree of similarity between object feature values that are based on the recognition results of the objects.

### Supplementary Note 3

The image processing system according to Supplementary note 2, wherein the similarity determining means performs the similarity determination based on weights of the degrees of similarity between the posture feature values and weights of the degrees of similarity between the object feature values.

### Supplementary Note 4

The image processing system according to any one of Supplementary notes 1 to 3, wherein the similarity determining means performs the similarity determination based on reliabilities of the persons whose postures are estimated and reliabilities of the estimated objects.

### Supplementary Note 5

The image processing system according to any one of Supplementary notes 1 to 4, wherein
the first image and the second image each include a plurality of images in a chronologically consecutive order, and
the similarity determining means performs the similarity determination based on a change in the estimated postures of the persons and a change in the recognized objects.

### Supplementary Note 6

The image processing system according to any one of Supplementary notes 1 to 5, wherein the similarity determining means performs the similarity determination based on relationships between the persons and the objects, the relationships being based on the estimation results of the postures of the persons and the recognition results of the objects.

### Supplementary Note 7

The image processing system according to Supplementary note 6, wherein the similarity determining means performs the similarity determination based on a degree of similarity between posture feature values of the postures of the persons, a degree of similarity between object feature values of the objects, and a degree of similarity between relationship feature values that are based on the relationships between the persons and the objects.

### Supplementary Note 8

The image processing system according to Supplementary note 7, wherein the similarity determining means performs the similarity determination based on weights of the degrees of similarity between the posture feature values, weights of the degrees of similarity between the object feature values, and weights of the degrees of similarity between the relationship feature values.

### Supplementary Note 9

The image processing system according to Supplementary note 7 or 8, wherein the relationship feature value indicating the relationship between each of the persons and a respective one of each of the objects includes a distance relationship feature value that is based on a distance between the person and the object, an orientation relationship feature value that is based on an orientation of the person and the object, and a positional relationship feature value that is based on a positional relationship of the person and the object.

### Supplementary Note 10

The image processing system according to Supplementary note 9, wherein the distance between the person and the object that the distance relationship feature value is based on is a distance between a person region that includes the person whose posture is estimated and an object region that includes the recognized object.

### Supplementary Note 11

The image processing system according to Supplementary note 10, wherein the distance between the person and the object includes any of a distance between a center point of the person region and a center point of the object region, a distance between closest points of the person region and of the object region, a distance between farthest points of the person region and of the object region, and a distance between a vertex of the person region and a vertex of the object region.

### Supplementary Note 12

The image processing system according to Supplementary note 10 or 11, wherein the distance relationship feature value is a feature value obtained by normalizing the distance between the person and the object by a normalization parameter.

### Supplementary Note 13

The image processing system according to Supplementary note 12, wherein the normalization parameter includes any of an image size of the first image and an image size of the second image, a height of the person that is based on the estimated posture of the person, a mean of a size of the person region and a size of the object region, and Intersection over Union (IoU) between the person region and the object region.

### Supplementary Note 14

The image processing system according to any one of Supplementary notes 10 to 13, wherein the distance between the person and the object is a distance, in a three-dimensional space, obtained from a camera parameter adopted when the first and the second image are captured.

### Supplementary Note 15

The image processing system according to any one of Supplementary notes 9 to 14, wherein the orientation of the person that the orientation relationship feature value is based on includes any of an orientation of a body of the person that is based on the estimated posture of the person, an orientation of a face of the person that is recognized from an image of the person, and an orientation of a line of sight of the person that is recognized from the image of the person.

### Supplementary Note 16

The image processing system according to Supplementary note 15, wherein the orientation relationship feature value is a feature value that is based on a degree of similarity between the orientation of the person and an orientation of a line connecting the person and the object.

### Supplementary Note 17

The image processing system according to Supplementary note 15 or 16, wherein the orientation of the person is an orientation, in a three-dimensional space, obtained from a camera parameter adopted when the first and the second image are captured.

### Supplementary Note 18

The image processing system according to any one of Supplementary notes 9 to 17, wherein the positional relationship that the positional relationship feature value is based on is a positional relationship between one point in one of the persons whose posture is estimated and the estimated object and a plurality of points in the other of the persons whose posture is estimated and the estimated object.

### Supplementary Note 19

The image processing system according to Supplementary note 18, wherein the point in the person is an articulation point of the person that is based on the estimated posture of the person.

### Supplementary Note 20

The image processing system according to Supplementary note 18 or 19, wherein the positional relationship between the one point and the plurality of points includes any of distances along a plurality of lines each connecting a point in the person and a point in the object, normalized values of the distances along the plurality of lines, and vectors of the plurality of lines.

### Supplementary Note 21

The image processing system according to Supplementary note 20, wherein the similarity determining means performs the similarity determination based on any of a degree of similarity between the distances along the plurality of lines, a degree of similarity between the normalized values of the distances along the plurality of lines, and a degree of similarity between the vectors of the plurality of lines.

### Supplementary Note 22

The image processing system according to Supplementary note 20, wherein the positional relationship feature value indicates an order of a plurality of points in the person or in the object corresponding to the distances along the plurality of lines.

### Supplementary Note 23

The image processing system according to any one of Supplementary notes 18 to 22, wherein the positional relationship between the one point and the plurality of points is a positional relationship, in a three-dimensional space, obtained from a camera parameter adopted when the first and the second image are captured.

### Supplementary Note 24

The image processing system according to any one of Supplementary notes 1 to 23, further comprising Human Object Interaction (HOI) detection acquiring means for acquiring an HOI detection result of HOI detection performed on each of the first and the second image, wherein the similarity determining means performs a first similarity determination that is based on the estimation results of the postures of the persons and the recognition results of the objects and a second similarity determination that is based on the HOI detection results.

### Supplementary Note 25

The image processing system according to Supplementary note 24, wherein the HOI detection acquiring means performs the HOI detection on the first or the second image based on the first or the second image.

### Supplementary Note 26

The image processing system according to Supplementary note 24 or 25, wherein the similarity determining means performs the second similarity determination based on the HOI detection result of performing the HOI detection based on the first image and the acquired HOI detection result of the second image.

### Supplementary Note 27

The image processing system according to any one of Supplementary notes 24 to 26, wherein the similarity determining means performs the similarity determination with either of the first similarity determination and the second similarity determination being weighted or the first similarity determination and the second similarity determination being weighted in accordance with a reliability of a detection result of the HOI detection.

### Supplementary Note 28

The image processing system according to any one of Supplementary notes 1 to 27, wherein
the first image is a query image,
the second image includes a plurality of search target images, and
the similarity determining means searches for an image similar to the query image from among the plurality of search target images based on a result of the similarity determination.

### Supplementary Note 29

The image processing system according to Supplementary note 28, further comprising a database configured to store the estimation results of the postures of the persons and the recognition results of the objects from the plurality of search target images,
wherein the similarity determining means searches for an image similar to the query image from among the plurality of search target images by referring to the database.

### Supplementary Note 30

The image processing system according to any one of Supplementary notes 1 to 29, wherein
the posture estimation acquiring means estimates the posture of the person included in the first image or the person included in the second image based on the first or the second image, and
the object recognition acquiring means recognizes the object included in the first image or the person included in the second image based on the first or the second image.

### Supplementary Note 31

The image processing system according to Supplementary note 30, wherein the posture estimation acquiring means estimates a pose structure of the person as the posture of the person included in the first image or the person included in the second image based on the first or the second image.

### Supplementary Note 32

The image processing system according to Supplementary note 30 or 31, wherein the object recognition acquiring means recognizes an object class of the object included in the first image or the object included in the second image based on the first and the second image.

### Supplementary Note 33

The image processing system according to any one of Supplementary notes 30 to 32, wherein the similarity determining means performs the similarity determination based on the estimation result of the posture of the person estimated based on the first image and the recognition result of the object recognized based on the first image as well as on the acquired estimation result of the posture of the person in the second image and the acquired recognition result of the object in the second image.

### Supplementary Note 34

An image processing method comprising:
acquiring an estimation result of estimating a posture of a person included in a first image and a person included in a second image;
acquiring a recognition result of recognizing an object, other than the persons, included in the first image and an object included in the second image; and
performing a similarity determination of the similarity of the first image to the second image based on the estimation results of the postures of the persons and the recognition results of the objects.

### Supplementary Note 35

A non-transitory computer-readable medium storing an image processing program that causes a computer to execute the processes of:
acquiring an estimation result of estimating a posture of a person included in a first image and a person included in a second image;
acquiring a recognition result of recognizing an object, other than the persons, included in the first image and an object included in the second image; and
performing a similarity determination of the similarity of the first image to the second image based on the estimation results of the postures of the persons and the recognition results of the objects.

### REFERENCE SIGNS LIST

1, 10 IMAGE PROCESSING SYSTEM
11 POSTURE ESTIMATION ACQUIRING UNIT
12 OBJECT RECOGNITION ACQUIRING UNIT
13 SIMILARITY DETERMINING UNIT
20 COMPUTER
21 PROCESSOR
22 MEMORY
100 IMAGE PROCESSING APPARATUS
101 IMAGE ACQUIRING UNIT
102 POSTURE ESTIMATING UNIT
103 OBJECT RECOGNIZING UNIT
104 FEATURE VALUE CALCULATING UNIT
105 SEARCH UNIT
106 INPUT UNIT
107 DISPLAY UNIT
108 SORTING UNIT
109 HOI DETECTING UNIT
110 DATABASE
200 IMAGE PROVIDING APPARATUS
300 HUMAN MODEL

What is claimed is:

1. An image processing system comprising:
at least one memory storing instructions, and
at least one processor configured to execute the instructions stored in the at least one memory to;
acquire an estimation result of estimating a posture of a person included in a first image and a person included in a second image;
acquire a recognition result of recognizing an object, other than the persons, included in the first image and an object included in the second image; and
perform a similarity determination of the similarity of the first image to the second image based on the estimation results of the postures of the persons and the recognition results of the objects.

2. The image processing system according to claim 1, wherein the at least one processor is further configured to execute the instructions stored in the at least one memory to perform the similarity determination based on a degree of similarity between posture feature values that are based on the estimation results of the postures of the persons and a degree of similarity between object feature values that are based on the recognition results of the objects.

3. The image processing system according to claim 2, wherein the at least one processor is further configured to execute the instructions stored in the at least one memory to perform the similarity determination based on weights of the degrees of similarity between the posture feature values and weights of the degrees of similarity between the object feature values.

4. The image processing system according to claim 1, wherein the at least one processor is further configured to execute the instructions stored in the at least one memory to perform the similarity determination based on reliabilities of the persons whose postures are estimated and reliabilities of the recognized objects.

5. The image processing system according to claim 1, wherein
the first image and the second image each include a plurality of images in a chronologically consecutive order, and
the at least one processor is further configured to execute the instructions stored in the at least one memory to perform the similarity determination based on a change in the estimated postures of the persons and a change in the recognized objects.

6. The image processing system according to claim 1, wherein the at least one processor is further configured to execute the instructions stored in the at least one memory to perform the similarity determination based on relationships between the persons and the objects, the relationships being based on the estimation results of the postures of the persons and the recognition results of the objects.

7. The image processing system according to claim 6, wherein the at least one processor is further configured to execute the instructions stored in the at least one memory to perform the similarity determination based on a degree of similarity between posture feature values of the postures of the persons, a degree of similarity between object feature values of the objects, and a degree of similarity between relationship feature values that are based on the relationships between the persons and the objects.

8. The image processing system according to claim 7, wherein the at least one processor is further configured to execute the instructions stored in the at least one memory to perform the similarity determination based on weights of the degrees of similarity between the posture feature values, weights of the degrees of similarity between the object feature values, and weights of the degrees of similarity between the relationship feature values.

9. The image processing system according to claim 7, wherein the relationship feature value indicating the relationship between each of the persons and a respective one of each of the objects includes a distance relationship feature value that is based on a distance between the person and the object, an orientation relationship feature value that is based on an orientation of the person and the object, and a positional relationship feature value that is based on a positional relationship of the person and the object.

10. The image processing system according to claim 9, wherein the distance between the person and the object that the distance relationship feature value is based on is a distance between a person region that includes the person whose posture is estimated and an object region that includes the recognized object.

11. The image processing system according to claim 10, wherein the distance between the person and the object includes any of a distance between a center point of the person region and a center point of the object region, a distance between closest points of the person region and of the object region, a distance between farthest points of the person region and of the object region, and a distance between a vertex of the person region and a vertex of the object region.

12. The image processing system according to claim 10, wherein the distance relationship feature value is a feature value obtained by normalizing the distance between the person and the object by a normalization parameter.

13. The image processing system according to claim 12, wherein the normalization parameter includes any of an image size of the first image and an image size of the second image, a height of the person that is based on the estimated posture of the person, a mean of a size of the person region and a size of the object region, and Intersection over Union (IoU) between the person region and the object region.

14. The image processing system according to claim 10, wherein the distance between the person and the object is a distance, in a three-dimensional space, obtained from a camera parameter adopted when the first and the second image are captured.

15. The image processing system according to claim 9, wherein the orientation of the person that the orientation relationship feature value is based on includes any of an orientation of a body of the person that is based on the estimated posture of the person, an orientation of a face of the person that is recognized from an image of the person, and an orientation of a line of sight of the person that is recognized from the image of the person.

16. The image processing system according to claim 15, wherein the orientation relationship feature value is a feature value that is based on a degree of similarity between the orientation of the person and an orientation of a line connecting the person and the object.

17. The image processing system according to claim 15, wherein the orientation of the person is an orientation, in a three-dimensional space, obtained from a camera parameter adopted when the first and the second image are captured.

18. The image processing system according to claim 9, wherein the positional relationship that the positional relationship feature value is based on is a positional relationship between one point in one of the persons whose posture is estimated and the estimated object and a plurality of points in the other of the persons whose posture is estimated and the recognized object.

19-33. (canceled)

34. An image processing method comprising:
acquiring an estimation result of estimating a posture of a person included in a first image and a person included in a second image;
acquiring a recognition result of recognizing an object, other than the persons, included in the first image and an object included in the second image; and
performing a similarity determination of the similarity of the first image to the second image based on the estimation results of the postures of the persons and the recognition results of the objects.

35. A non-transitory computer-readable medium storing an image processing program that causes a computer to execute the processes of:
acquiring an estimation result of estimating a posture of a person included in a first image and a person included in a second image;
acquiring a recognition result of recognizing an object, other than the persons, included in the first image and an object included in the second image; and
performing a similarity determination of the similarity of the first image to the second image based on the estimation results of the postures of the persons and the recognition results of the objects.
